(19) United States
(12) Patent Application Publication
(10) Pub. No.: US 2025/0013477 A1
(43) Pub. Date: Jan. 9, 2025

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: MASAYUKI YAMADA, Kanagawa (JP)

(21) Appl. No.: 18/754,302

(22) Filed: Jun. 26, 2024

(30) Foreign Application Priority Data
Jul. 7, 2023 (JP) 2023-112471

(51) Int. Cl. G06F 9/451; H04N 1/00

(52) U.S. Cl. CPC G06F 9/453; H04N 1/00474

(57) ABSTRACT

In a case where, in a state in which a screen of a first application among a plurality of applications is displayed, an instruction for displaying a screen of a second application different from the first application is accepted, control is performed such that display is switched from the screen of the first application to a screen of the second application. In a case of switching the display from the screen of the second application to the screen of the first application, (a) if the second application is not a predetermined application, the screen of the first application that is initialized is displayed, and (b) if the second application is the predetermined application, the screen of the first application that is not initialized is displayed.

### BACKGROUND OF THE INVENTION

### Field of the Invention

The present invention relates to an information processing apparatus, a method, and a non-transitory computer-readable storage medium storing a program.

### Description of the Related Art

In an information device such as an image processing apparatus, there is known a technique of displaying help information or an access means to help information in a case where a user has difficulty in an operation (Japanese Patent Laid-Open No. 2018-156610). Patent literature 1 discloses a technique of displaying a help screen according to a displayed application when a user presses a help button arranged in the upper portion of a screen.

Upon accepting an instruction to display an application screen corresponding to a function executable by an apparatus, various kinds of settings are preferably in an initial state. On the other hand, in a case where a help function is executed during display of an application screen corresponding to a desired function, if the screen returns to display of the immediately preceding application screen, settings before execution of the help function preferably remain.

### SUMMARY OF THE INVENTION

The present invention provides an information processing apparatus that improves convenience of use of an application by a user, a display control method, and a program.

The present invention in one aspect provides an information processing apparatus comprising: one or more memories that store instructions; and one or more processors configured to execute the instructions stored in the one or more memories to accept an instruction for displaying a screen corresponding to each of a plurality of applications; and perform, based on the accepted instruction, display control to display a screen of an application corresponding to the instruction, wherein in the display control, in a case where, in a state in which a screen of a first application among the plurality of applications is displayed, the instruction for displaying a screen of a second application different from the first application is accepted, control is performed such that display is switched from the screen of the first application to a screen of the second application, and in a case of switching the display from the screen of the second application to the screen of the first application, (a) if the second application is not a predetermined application, the screen of the first application that is initialized is displayed, and (b) if the second application is the predetermined application, the screen of the first application that is not initialized is displayed.

Further features of the present invention will become apparent from the following description of exemplary embodiments with reference to the attached drawings.

### BRIEF DESCRIPTION OF THE DRAWINGS

FIG. 1 is a view showing the hardware configuration of an image processing apparatus;

FIG. 2 is a view showing the configuration of a network system;

FIG. 3 is a view showing the configuration of a portable information terminal;

FIG. 4 is a view showing the functional module configuration of the image processing apparatus;

FIGS. 5A to 5D are views for explaining data held by applications;

FIG. 6 is a view showing the user interface screen of a home application;

FIG. 7 is a view for explaining data held by the home application;

FIG. 8 is a view for explaining data held by a window manager;

FIG. 9 is a sequence chart showing processing between modules;

FIG. 10 is a flowchart showing processing of the window manager;

FIGS. 11A and 11B are sequence charts showing processing between modules;

FIG. 12 is a view showing the user interface screen of a help application;

FIGS. 13A to 13D are flowcharts showing processing of the window manager;

FIG. 14 is a flowchart showing processing of the home application;

FIG. 15 is a flowchart showing processing of the home application;

FIG. 16 is a flowchart showing processing of the help application;

FIG. 17 is a view for explaining data held by the help application;

FIG. 18 is a sequence chart showing processing between modules;

FIGS. 19A and 19B are flowcharts showing processing of an operation processing unit;

FIG. 20 is a view for explaining data held by a transmission/FAX application;

FIG. 21 is a view showing the user interface screen of the transmission/FAX application;

FIGS. 22A and 22B are sequence charts showing processing between modules;

FIG. 23 is a flowchart showing processing of the transmission/FAX application;

FIG. 24 is a flowchart showing processing of the transmission/FAX application;

FIG. 25 is a view showing a screen configured to perform application assignment to buttons;

FIG. 26 is a flowchart showing processing of the home application; and

FIGS. 27A and 27B are flowcharts showing processing of the operation processing unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

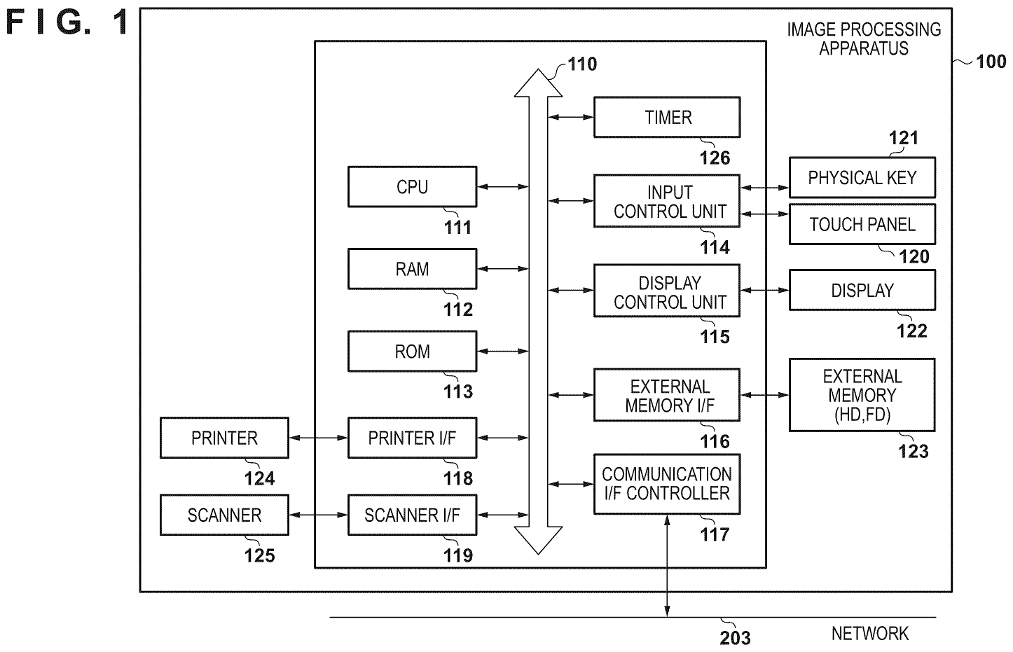

FIG. 1 is a view showing an example of the hardware configuration of an image processing apparatus 100 that is an information processing apparatus according to this embodiment. In FIG. 1, a CPU 111, a RAM 112, a ROM 113, an input control unit 114, a display control unit 115, an external memory I/F 116, a communication I/F controller 117, a printer I/F 118, and a scanner I/F 119 are connected to a system bus 110. Also, a touch panel 120, a physical key 121, a display 122, an external memory 123, a printer 124, a scanner 125, and a timer 126 are connected. The units connected to the system bus 110 are configured to be able to transmit/receive data to/from each other via the system bus 110.

The ROM 113 is a nonvolatile memory, and image data, other data, and various kinds of programs for the CPU 111 to operate are stored in predetermined areas. The RAM 112 is a volatile memory and is used as a temporary storage area such as the main memory or the work area of the CPU 111. The CPU 111 controls the units of the image processing apparatus 100 using the RAM 112 as a work memory in accordance with the programs stored in, for example, the ROM 113. Note that the programs for the CPU 111 to operate may be stored not in the ROM 113 but in the external memory (hard disk) 123.

The input control unit 114 accepts a user operation, generates a control signal according to the operation, and supplies it to the CPU 111. The input control unit 114 is connected to the touch panel 120 and the physical key 121, which are input devices capable of accepting user operations. The touch panel 120 is an input device configured to, for example, output coordinate information according to a touch position on a two-dimensionally constructed input part. Any of various types of touch panels such as a resistive film type, an electrostatic capacitance type, a surface acoustic wave type, an infrared type, an electromagnetic induction type, an image recognition type, and an optical sensor type can be used. The physical key 121 is a physically pressable input device including a numerical key, a start key, a stop key, and the like. The CPU 111 controls the units of the image processing apparatus 100 in accordance with a program based on a control signal generated and supplied by the input control unit 114 in accordance with a user operation performed for the input device. This can cause the image processing apparatus 100 to perform an operation according to the user operation.

The display control unit 115 outputs a display signal for causing the display 122 to display an image. For example, a display control signal generated by the CPU 111 in accordance with a program is supplied to the display control unit 115. The display control unit 115 generates a display signal based on the display control signal and outputs it to the display 122. For example, based on the display control signal generated by the CPU 111, the display control unit 115 causes the display 122 to display a GUI screen forming a Graphical User Interface GUI).

The touch panel 120 is configured integrally with the display 122. For example, the touch panel 120 is configured such that its light transmittance does not impede display of the display 122, and attached to the upper layer of the display surface of the display 122. Then, input coordinates on the touch panel 120 and display coordinates on the display 122 are associated with each other. Thus, a GUI can be configured as if the user were able to directly operate a screen displayed on the display 122.

For example, the external memory 123 such as a hard disk or a floppy disk, a CD or a DVD, or a memory card can be attached to the external memory I/F 116. Under the control of the CPU 111, data read out from the attached external memory 123 and data write to the external memory 123 are performed. The communication I/F controller 117 performs communication for, for example, various kinds of networks 203 such as a wired/wireless LAN 205, the Internet 206, and a public line 207 under the control of the CPU 111. The scanner I/F 119 controls image input from the scanner 125. The printer I/F 118 controls image output to the printer 124.

The timer 126 measures a time or a point of time. Under the control of the CPU 111, the timer 126 generates an interrupt signal to the CPU 111 at a predetermined time or when a predetermined time elapses from a predetermined start time. Alternatively, the timer 126 notifies the CPU 111 of the current time or a time elapsed from a predetermined time. Note that the timer 126 is incorporated in the CPU 111 in some cases.

In this embodiment, the image processing apparatus 100 will be described as a multifunctional peripheral including a print function and a scan function, but it may be a single function type printing apparatus having a print function or may be a scanner.

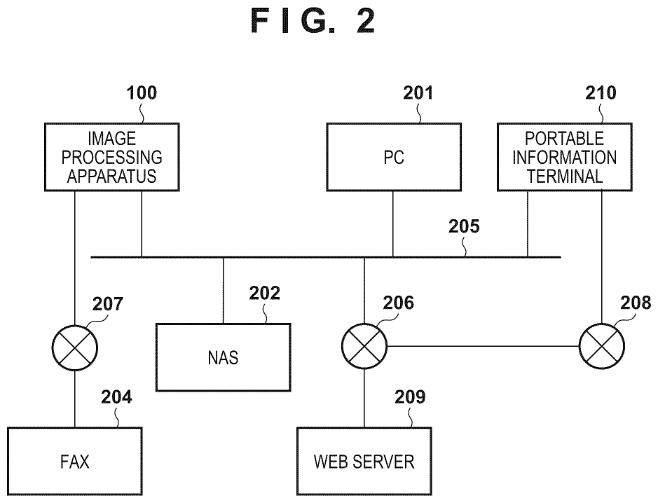

FIG. 2 is a block diagram showing an example of the configuration of a network system to which the image processing apparatus 100 shown in FIG. 1 is connected. When a print job is input from a PC 201 to the image processing apparatus 100, the image processing apparatus 100 processes the input print job, and outputs it from the printer 124. Alternatively, the image processing apparatus 100 reads an image from the scanner 125 and transfers it to the PC 201 via the network 203. Note that in FIG. 2, the PC 201 is connected to the image processing apparatus 100 via the LAN 205. However, the PC 201 may be connected via the Internet 206. The image processing apparatus 100 reads an image from the scanner 125, and holds it in a Network Attached Storage (NAS) 202 via the network 203 (the LAN 205 in FIG. 2). The image processing apparatus 100 transmits the image read from the scanner 125 to a FAX 204, and the FAX 204 prints the received image. Alternatively, the FAX 204 transmits an image to the image processing apparatus 100, and the image processing apparatus 100 prints the received image from the printer 124. As for the connection form between the image processing apparatus 100 and the FAX 204, these are connected via the public line 207 or using the Internet 206. A Web server 209, for example, provides help contents for explaining the use method of the image processing apparatus 100 to the image processing apparatus 100 or a portable information terminal 210 via the Internet 206. The portable information terminal 210 represented by a smartphone or a tablet is connected to the Internet 206 via the LAN 205 or a portable telephone line 208.

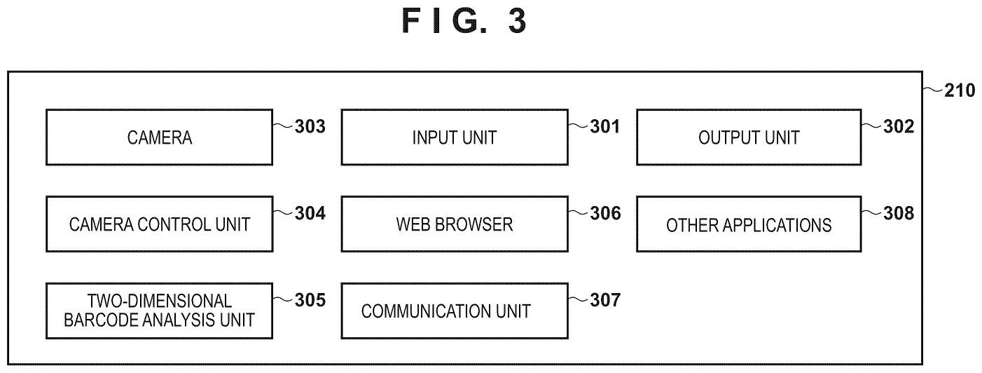

FIG. 3 is a schematic view showing the configuration of the portable information terminal 210. An input unit 301 such as a touch panel acquires a user operation on the portable information terminal 210. An output unit 302 such as a liquid crystal display or an organic EL presents information to the user. A camera control unit 304 controls a camera 303 that captures a moving image or still image. If an image captured by the camera 303 is a two-dimensional code, the camera control unit 304 analyzes the two-dimensional code in the image by a two-dimensional barcode analysis unit 305, thereby acquiring a character string embedded in the two-dimensional code. Furthermore, if the character string embedded in the two-dimensional code is a Uniform Resource Locator (URL), the camera control unit 304 sends the acquired URL to a Web browser 306. Based on the URL sent from the camera control unit 304, the Web browser 306 accesses the Web server 209 via a communication unit 307 and acquires content. Also, the Web browser 306 outputs the acquired content to the output unit 302. Other applications 308 can also be installed in the portable terminal 210, and functions other than a camera and a Web browser can be provided.

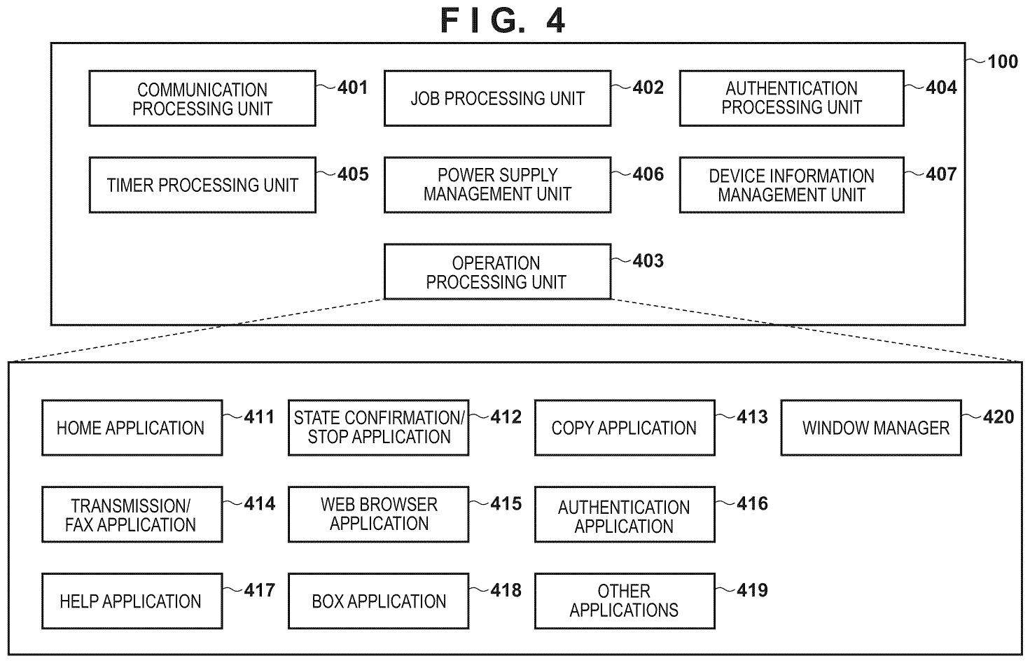

FIG. 4 is a block diagram showing an example of the module configuration of the image processing apparatus 100 shown in FIG. 1. The image processing apparatus 100 includes, as the module configuration, a communication processing unit 401, a job processing unit 402, an operation processing unit 403, an authentication processing unit 404, a timer processing unit 405, a power supply management unit 406, and a device information management unit 407. These functional units (modules) are implemented by the CPU 111 reading out a program stored in the ROM 113 or the external memory 123 to the RAM 112 and executing it.

The communication processing unit 401 executes analysis of communication contents received, via the communication I/F controller 117, from the PC 201, the NAS 202, the FAX 204, the Web server 209, or the like connected via the network 203 and communication control. The job processing unit 402 performs processing of various kinds of jobs executed by the image processing apparatus 100. More specifically, the job processing unit 402 executes a print job by controlling the printer 124, executes a scan job by controlling the scanner 125, or executes a transmission job by controlling the communication I/F controller 117. Also, the job processing unit 402 controls cancel processing or stop processing of the above-described various kinds of jobs.

The operation processing unit 403 controls the display control unit 115 and displays, on the display 122, various kinds of information to the user. The operation processing unit 403 also receives an operation instruction from the user, which is input from the physical key 121 and the touch panel 120, via the input control unit 114 and processes it. The authentication processing unit 404 receives a login/logout request from the user and performs authentication processing or processing for managing the user who uses the image processing apparatus 100. The timer processing unit 405 provides functions using the timer 126 to the operation processing unit 403 and other processing units. The power supply management unit 406 manages the power supply state of the image processing apparatus 100. The device information management unit 407 holds/manages information such as the model name and the destination/display language of the image processing apparatus 100.

The operation processing unit 403 includes applications 411 to 419 configured to provide, to the user, functions (print, scan, and the like) executable in the image processing apparatus 100. Each application provides a function to the user solely or in cooperation with another application. The home application 411 is used to present a list of applications usable in the image processing apparatus 100 to the user and display an application selected by the user. The state confirmation/stop application 412 is used to display a job execution state or stop a job under execution. The copy application 413 is used to implement a copy function of outputting, from the printer 124, an image read from the scanner 125. The transmission/FAX application 414 is used to implement a transmission/FAX function of transmitting, via the network 203, an image read from the scanner 125. The Web browser application 415 is used to implement a function of displaying content acquired from the Web server 209 via the network 203 on the display 122 or transmitting a form to the Web server 209. The authentication application 416 is used to implement a function of authenticating the user using the authentication processing unit 404 and allowing the user to log in to the image processing apparatus 100. The help application 417 is used to implement a help function of providing information as a help to an operation when the user has difficulty in an operation. The box application 418 is used to implement a box function of saving, as image data, an image read from the scanner 125. The other applications 419 indicate that an application corresponding to another function providable to the user exists. The other applications 419 include not only applications installed in the image processing apparatus 100 at the time of shipment from the factory, but also applications installed via the network 203 or the external memory 123.

The operation processing unit 403 further includes a window manager 420. The window manager 420 controls, via the display control unit 115, the display states of the applications 411 to 419 on the display 122. The window manager 420 also transmits a user operation acquired via the input control unit 114 as an event to the applications 411 to 419.

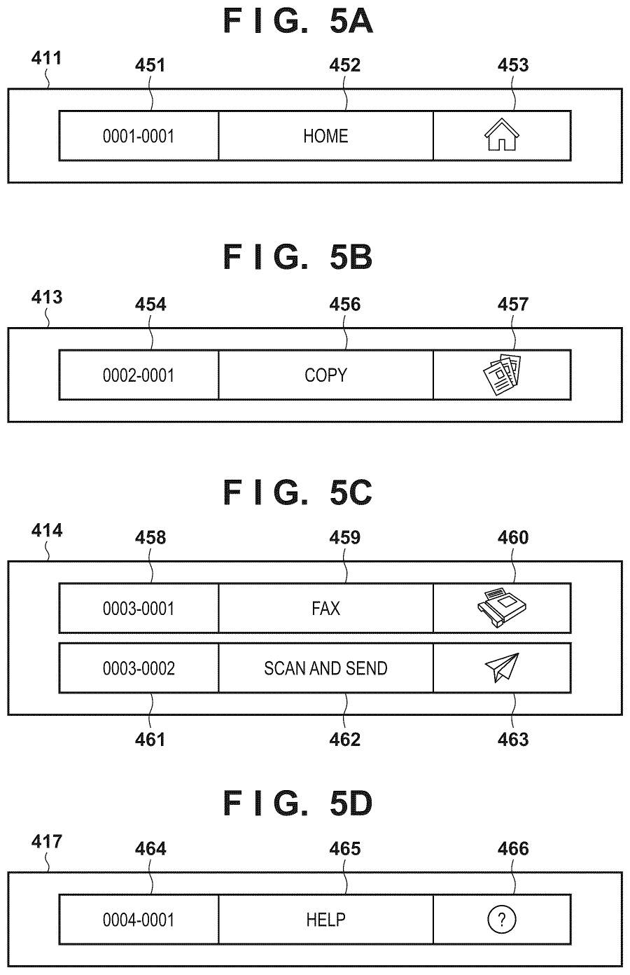

The applications 411 to 419 each include information of an application ID, an application name, and icon data. FIGS. 5A to 5D are views schematically showing an example of information of an application ID, an application name, and icon data held by each of the home application 411, the copy application 413, the transmission/FAX application 414, and the help application 417.

As shown in FIG. 5A, the home application 411 holds an application ID 451, an application name 452, and icon data 453. As shown in FIG. 5B, the copy application 413 holds an application ID 454, an application name 456, and icon data 457. As shown in FIG. 5D, the help application 417 holds an application ID 464, an application name 465, and icon data 466. Also, one application sometimes holds a plurality of sets of information of application IDs, application names, and icon data. As shown in FIG. 5C, the transmission/FAX application 414 holds a set of information of an application ID 458, an application name 459, and icon data 460 and a set of information of an application ID 461, an application name 462, and icon data 463. The information of the application IDs, the application names, and the icon data is held in the ROM 113 or the external memory 123. The application IDs are given to keep uniqueness in the image processing apparatus 100. A plurality of application names may be held in accordance with display languages.

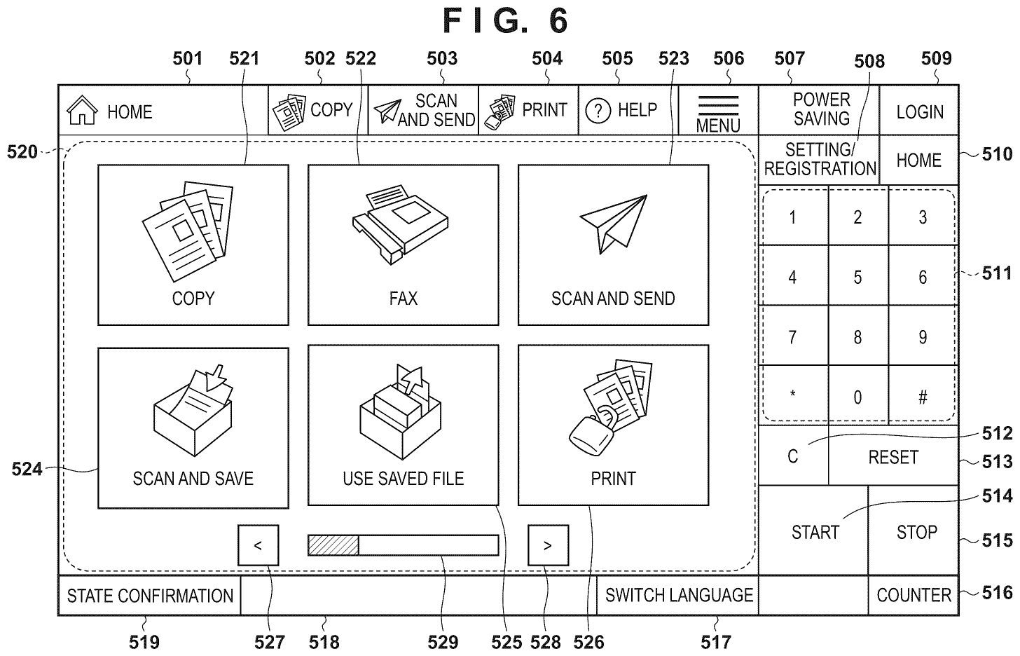

FIG. 6 is a view showing an example of the screen (home screen) of the home application 411 displayed on the display 122. In FIG. 6, a region 501 is a region to display the application name and the icon of the displayed application. Since the home application 411 is displayed in FIG. 6, the application name 452 and the icon data 453 of the home application 411 are displayed.

Short-cut buttons 502 to 505 are short-cut buttons used to switch the application to be displayed. Any of the applications 411 to 419 can be assigned to each short-cut button. In FIG. 6, the copy application 413 is assigned to the short-cut button 502, “scan and send” of the transmission/FAX application 414 is assigned to the short-cut button 503, a print application (one of the other applications 419) is assigned to the short-cut button 504, and the help application 417 is assigned to the short-cut button 505. Details of short-cut button assignment will be described later.

If the user presses a menu button 506, a menu used to do various kinds of settings of the displayed application or the image processing apparatus 100 is displayed. If the user presses a power saving button 507, the power supply management unit 406 sets the image processing apparatus 100 in the power saving state. If the user presses the setting/registration button 508, the home application 411 displays a setting/registration application (one of the other applications 419). The user can do various kinds of settings of the image processing apparatus 100 using the setting/registration application. If the image processing apparatus 100 is in a non-authenticated state, “log in” is displayed on an authentication button 509. Here, if the user presses the authentication button 509, the home application 411 displays the authentication application 416. The user can log in to the image processing apparatus 100 (set the image processing apparatus 100 in an authenticated state) by operating the authentication application 416. If the image processing apparatus 100 is in the authenticated state, “log out” is displayed on the authentication button 509. Here, if the user presses the authentication button 509, the home application 411 notifies the authentication processing unit 404 of the logout of the user, and the image processing apparatus 100 is set in the non-authenticated state.

If the user presses the home button 510 during display of an application other than the home application 411, the home application 411 is displayed. A ten-key pad 511 is a ten-key pad used to input a numerical value. A clear key 512 is a clear key used to clear an input. A reset key 513 is a reset key used to return the state of the displayed application or the image processing apparatus 100 to the initial state. The start key 514 is a start key used to start a job. A stop key 515 is a stop key used to stop a job under execution. If the user presses a counter confirmation key 516, the home application 411 displays a counter confirmation application (one of the other applications 419). Using the counter confirmation application, the user can acquire the information of the number of pages printed by the image processing apparatus 100 or the license of an application installed in the image processing apparatus 100. A language switch button 517 is a button used to switch a language used for screen display. A status display region 518 is a region to display the device state of the image processing apparatus 100. A state confirmation button 519 is a button used to display the screen of the state confirmation/stop application 412.

Application switch buttons 521 to 526 are buttons configured to switch an application be displayed. Any of the applications 411 to 419 is assigned to each application switch button. In FIG. 6, “copy” of the copy application 413 is assigned to the application switch button 521, “fax” of the transmission/FAX application 414 is assigned to the application switch button 522, and “scan and send” of the transmission/FAX application 414 is assigned to the application switch button 523. “Scan and save” of the box application 418 is assigned to the application switch button 524, “use saved file” of the box application 418 is assigned to the application switch button 525, and “print” of the print application is assigned to the application switch button 526. Application switch button assignment will be described later. FIG. 6 shows six application switch buttons, but there exist application switch buttons that are not displayed. The user can change the application switch buttons displayed on the screen by pressing home screen display switch buttons 527 and 528. For example, if the user presses the home screen display switch button 528 in the state shown in FIG. 6, a seventh application switch button is displayed at the position of the application switch button 521, and an eighth application switch button is displayed at the position of the application switch button 522 (this also applies to the application switch buttons 523 to 526). If the user presses the home screen display switch button 527 in a state in which the seventh application switch button is displayed at the position of the application switch button 521, the state returns to the state shown in FIG. 6. An indicator 529 is an indicator that indicates the display state of the application switch buttons.

In FIG. 6, the region where the region 501 to the state confirmation button 519 are displayed is an application common region which is continuously displayed even if the displayed application is switched. However, the contents of the display change depending on the state of the device of the application. On the other hand, a region 520 is an application individual region that is a drawing region in which a displayed application individually performs drawing. That is, the short-cut buttons 502 to 505 displayed in the application common region are continuously displayed even if the displayed application changes. However, the application switch buttons 521 to 526 are not displayed if an application other than the home application 411 is displayed. Note that the buttons displayed in the application common region may be configured as physical keys. Both the buttons and the physical keys may exist. A user operation for the buttons 511 to 515 is switched for each displayed application by the window manager 420.

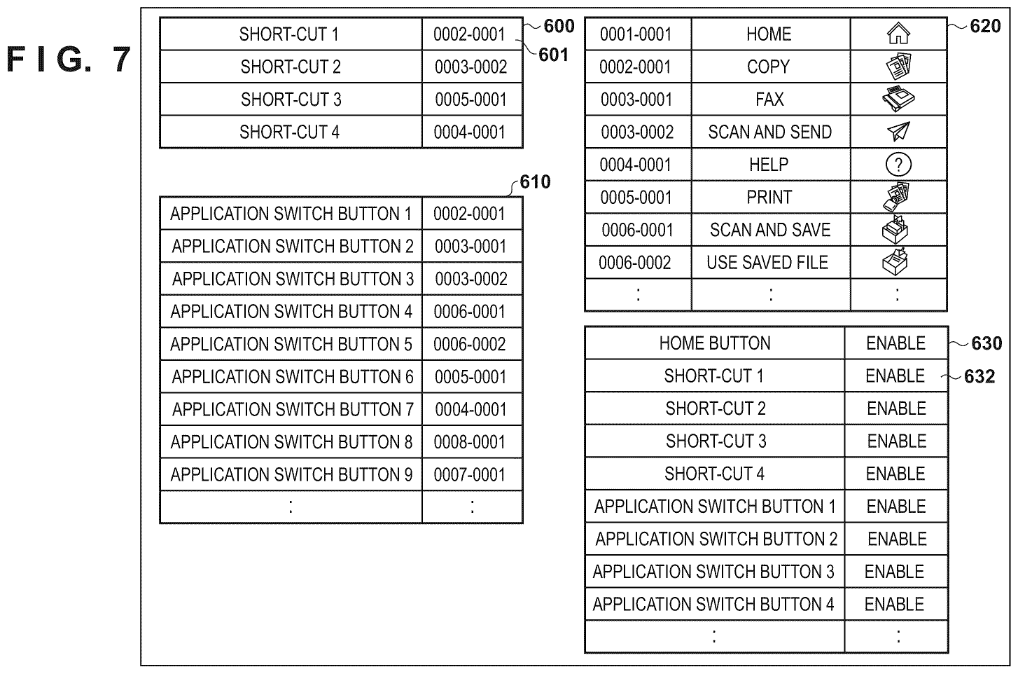

FIG. 7 is a view showing data held by the home application 411. Short-cut button assignment data 600 shown in FIG. 7 schematically shows assignment data of the short-cut buttons. As shown in FIG. 7, the short-cut button assignment data 600 holds application IDs in association with the four short-cut buttons. For example, an application ID “0002-0001” is assigned short-cut button 1.

Link data 620 schematically shows data for linking an application ID with an application name and icon data corresponding to it. For example, an application name “home” and icon data thereof are linked with the application ID “0001-0001”. The home application 411 displays the short-cut buttons 502 to 505 using the short-cut button assignment data 600 and the link data 620. For example, since the application ID “0002-0001” is assigned to short-cut button 1, an application name “copy” corresponding to it and icon data thereof are displayed on the short-cut button 502.

Application switch button assignment data 610 schematically shows assignment data of the application switch buttons. The home application 411 displays the application switch buttons 521 to 526 using the application switch button assignment data 610 and the link data 620, like the short-cut buttons.

A button enable/disable flag 630 schematically shows data (button enable/disable flag) representing an enable/disable state of each button (see FIG. 6) displayed by the home application 411. For example, in the state shown in FIG. 7, all the home button, the short-cut buttons 502 to 505, and the application switch buttons 521 to 524 are enabled. In this case, if the user presses one of these buttons, a predetermined operation corresponding to the pressed button is performed. On the other hand, if there is a disabled item in the button enable/disable flag 630, the operation of the corresponding button is disabled. For example, if a flag 632 corresponding to the short-cut button 502 is disabled, nothing occurs even if the user presses the short-cut button 502.

The short-cut button assignment data 600 and the application switch button assignment data 610 are held in the external memory 123, and loaded into the RAM 112 at the time of activation of the home application 411. Also, the contents of the short-cut button assignment data 600 and the application switch button assignment data 610 can be written by a user operation. On the other hand, the link data 620 is generated by the home application 411 based on the data held by the applications shown in FIGS. 5A to 5D and held in the RAM 112. The button enable/disable flag 630 is also held in the RAM 112.

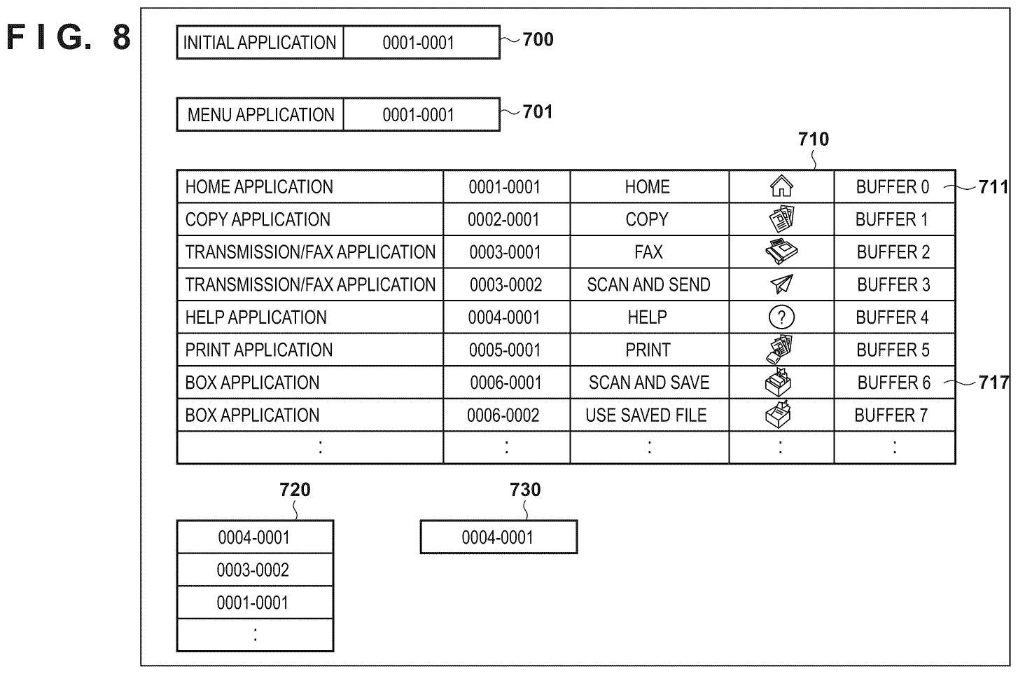

FIG. 8 is a view schematically showing data held by the window manager 420. Initial application information 700 holds information of an initial application. The initial application is an application displayed immediately after the activation of the image processing apparatus 100. FIG. 8 shows that the application of the application ID “0001-0001” is the initial application. The initial application can be changed by a setting operation of the user. For example, if the copy application 413 is set to the initial application, the application displayed immediately after the activation of the image processing apparatus 100 is the screen of the copy application 413. This allows the user who often uses the copy application to save the labor of pressing the application switch button 521 or the short-cut button 502 in the state of the screen shown in FIG. 6 and displaying the copy application. On the other hand, to use an application other than the copy application 413, it is necessary to use the short-cut buttons 502 to 505 or invoke the home application 411 from the home button 510. The initial application information 700 is held in the external memory 123 and loaded into the RAM 112.

Menu application information 701 holds information of a menu application. The menu application is an application used to switch the application to be displayed. FIG. 8 shows that the application (home application 411) of the application ID “0001-0001” is the menu application. The menu application information 701 is held in the external memory 123 or the ROM 113 and loaded into the RAM 112.

Application information 710 holds information about each application. The application information will be described later. A window stack 720 holds layer information of a displayed application. The window stack will be described later. The application information 710 and the window stack 720 are held in the RAM 112 and updated in accordance with the operation of the window manager 420.

Help application information 730 holds information of an application used for help. The window manager 420 handles the application used for help differently from normal applications. FIG. 8 shows that the application of the application ID “0004-0001” is the application used for help. The help application information 730 is held in the external memory 123 or the ROM 113 and loaded into the RAM 112.

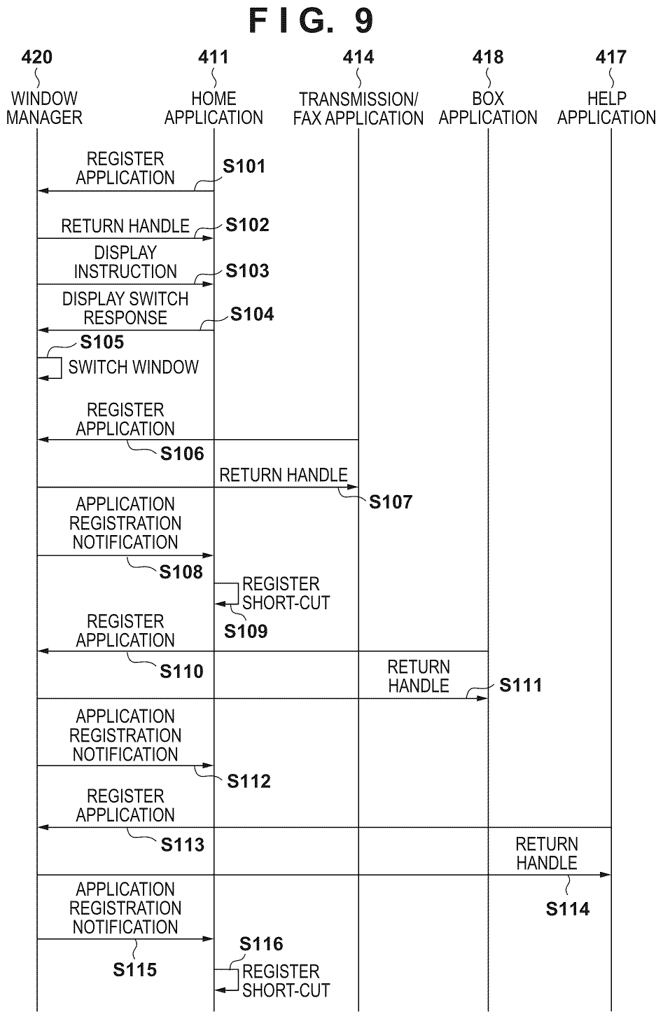

FIG. 9 is a sequence chart showing an example of processing to the operation processing unit 403 at the time of activation of the image processing apparatus 100. The procedure shown in FIG. 9 is held as a program in the external memory 123 or the ROM 113 and implemented by the CPU 111 loading it into the RAM 112 and executing it. When the image processing apparatus 100 is activated, in S101, the home application 411 registers information of its own in the window manager 420. At this time, the home application 411 notifies the application ID 451, the application name 452, and the icon data 453 held by itself. The window manager 420 links the notified information with the home application 411 and holds it in the application information 710. Furthermore, the window manager 420 generates a drawing buffer for the home application 411, links it with the home application, and holds it in a drawing buffer 711 in the application information 710. At this time, the window manager 420 compares the contents of the menu application information 701 with the application ID notified from the home application 411, and determines that the home application 411 is the menu application because these are identical.

The drawing buffer including both the application common region and the application individual region is thus generated. Note that as for the notification method in the processing shown in FIG. 9, a method according to the configuration of the image processing apparatus 100 such as inter-application communication, method call, or communication via the communication I/F controller 117 can be used.

In S102, the window manager 420 notifies the home application 411 of a handle to the drawing buffer generated in S101. Next, in S103, the window manager 420 compares the contents of the initial application information 700 with the application ID notified from the home application 411, and determines that the home application 411 is the initial application because these are identical. Based on the determination result, the window manager 420 notifies the home application 411 of a display instruction.

Next, in S104, the home application 411 draws itself in a drawing region acquired based on the handle notified in S102, and notifies the window manager 420 of a display switch response. Next, in S105, the window manager 420 switches the display to the home application 411. At this time, the window manager 420 sets the application ID of the home application 411 to the uppermost position of the window stack 720 and controls such that the drawing buffer 711 for the home application 411 becomes the target of the input control unit 114 or the display control unit 115.

In S106, the transmission/FAX application 414 registers information of its own in the window manager 420. At this time, the transmission/FAX application 414 notifies the application ID 458, the application name 459, and the icon data 460 held by itself. Furthermore, the transmission/FAX application 414 notifies the application ID 461, the application name 462, and the icon data 463. The window manager 420 links the notified information with the transmission/FAX application 414 and holds it in the application information 710. Furthermore, the window manager 420 generates a drawing buffer for the transmission/FAX application 414, links it with the transmission/FAX application, and holds it in the application information 710. Here, since two application IDs are notified from the transmission/FAX application 414 to the window manager 420, two sets of information are held in the application information 710. Next, in S107, the window manager 420 notifies the transmission/FAX application 414 of a handle to the drawing buffer generated in S106.

In S108, the window manager 420 notifies the home application 411 of the registration of the transmission/FAX application 414 based on the menu application information 701. Here, the window manager 420 notifies the home application 411 of the application IDs, application names, and icon data notified in S106. The home application 411 registers the notified application IDs, application names, and icon data in the link data 620. Furthermore, based on the notified application IDs, application names, and icon data and the application switch button assignment data 610, the home application 411 updates the application switch buttons 522 and 523. For example, the notified application names and icon data are displayed on the application switch buttons 522 and 523.

In S109, the home application 411 refers to the short-cut button assignment data 600, and performs short-cut registration. Since, among the application IDs notified in S108, “0003-0002” is registered in the short-cut button assignment data 600, the corresponding short-cut button 503 is updated. At this time, the home application 411 refers to the link data 620, and displays, on the short-cut button 503, the application name “scan and send” and icon data corresponding to “0003-0002”.

In S110, the box application 418 registers information of its own in the window manager 420. At this time, the box application 418 notifies the application ID, the application name, and the icon data held by itself. The window manager 420 links the notified information with the box application 418 and holds it in the application information 710. Furthermore, the window manager 420 generates a drawing buffer for the box application 418, links it with the box application, and holds it in the application information 710. Next, in S111, the window manager 420 notifies the box application 418 of a handle to the drawing buffer generated in S110.

In S112, the window manager 420 notifies the home application 411 of the registration of the box application 418 based on the menu application information 701. Here, the window manager 420 notifies the home application 411 of the application ID, application name, and icon data notified in S110. The home application 411 registers the notified application ID, application name, and icon data in the link data 620. Furthermore, based on the notified application ID, application name, and icon data and the application switch button assignment data 610, the home application 411 updates the application switch buttons 524 and 525. Note that since the application ID notified in S110 does not exist in the short-cut button assignment data 600, short-cut registration is not performed.

In S113, the help application 417 registers information of its own in the window manager 420. At this time, the help application 417 notifies the application ID 464, the application name 465, and the icon data 466 held by itself. The window manager 420 links the notified information with the help application 417 and holds it in the application information 710. Furthermore, the window manager 420 generates a drawing buffer for the help application 417, links it with the help application, and holds it in the application information 710. Next, in S114, the window manager 420 notifies the help application 417 of a handle to the drawing buffer generated in S113.

In S115, the window manager 420 notifies the home application 411 of the registration of the help application 417 based on the menu application information 701. Here, the window manager 420 notifies the home application 411 of the application ID, application name, and icon data notified in S113. The home application 411 links the notified application ID, application name, and icon data and registers them in the link data 620. Furthermore, based on the notified application ID, application name, and icon data and the application switch button assignment data 610, the home application 411 updates the application switch button. Note that since the application ID of the help application 417 is located at the seventh position in the application switch button assignment data 610, it is not displayed in the screen shown in FIG. 6.

In S116, the home application 411 refers to the short-cut button assignment data 600, and performs short-cut registration. Since the application ID “0004-0001” notified in S115 is registered in the short-cut button assignment data 600, the corresponding short-cut button 505 is updated. Note that the application registration processing is similarly performed even for the applications 412, 413, and 415 to 419, as in S106 to S116, although not shown in FIG. 9.

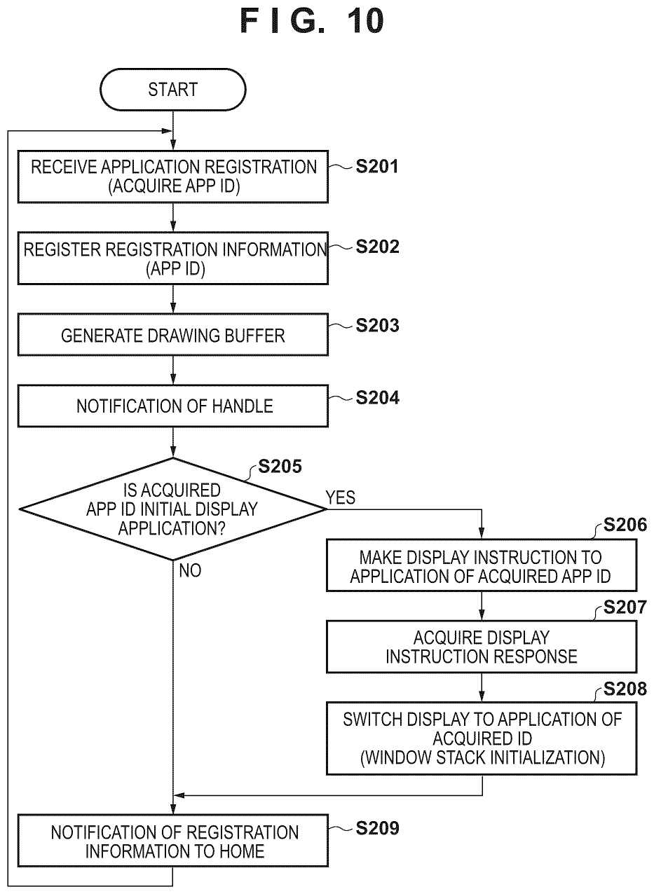

FIG. 10 is a flowchart showing processing of the window manager 420 at the time of activation of the image processing apparatus 100. The procedure shown in FIG. 10 is held as a program in the external memory 123 or the ROM 113 and implemented by the CPU 111 loading it into the RAM 112 and executing it.

First, in step S201, the window manager 420 receives application registration from the applications 411 to 419. At this time, an application ID, an application name, and icon data are received. Next, in step S202, the window manager 420 registers the registration information (the application ID, the application name, and the icon data) received in step S201 in the application information 710.

Next, in step S203, the window manager 420 generates a drawing buffer corresponding to the application ID received in step S201. The generated drawing buffer is linked with the application ID and registered in the application information 710. Next, in step S204, the window manager 420 notifies the application whose application information registration is received in step S201 of a handle to the drawing buffer generated in step S203.

In step S205, the window manager 420 compares the application ID received in step S201 with the application ID held in the initial application information 700, and determines whether the application whose registration is received in step S201 is an initial display application. As the result of the determination, if the application ID received in step S201 equals the application ID held in the initial application information 700, the process advances to step S206. If the application IDs do not equal, the process advances to step S209.

In step S206, the window manager 420 notifies the application whose registration is received in step S201, that is, the application whose application ID equals the application ID held in the initial application information 700 of a display instruction. Next, in step S207, the window manager 420 receives a response to the display instruction in step S206.

In step S208, the window manager 420 switches the display to the application whose registration is received in step S201. At this time, the window stack 720 is initialized, and the application ID whose registration is received in step S201 is held at the uppermost position. That is, the application ID received here is the application ID of the application equal to the application ID held in the initial application information 700. Furthermore, the window manager 420 controls the operation processing unit 403 such that the drawing buffer generated in step S203 becomes the target of the input control unit 114 or the display control unit 115.

In step S209, the window manager 420 notifies the menu application of the application ID, application name and icon data received in step S201. At this time, the window manager 420 refers to the menu application information 701. For example, since the application ID held in the menu application information 701 is the application ID “0001-0001” of the home application 411, the application of the notification destination is the home application 411. When step S209 is ended, the process returns to step S201 to receive registration from another application.

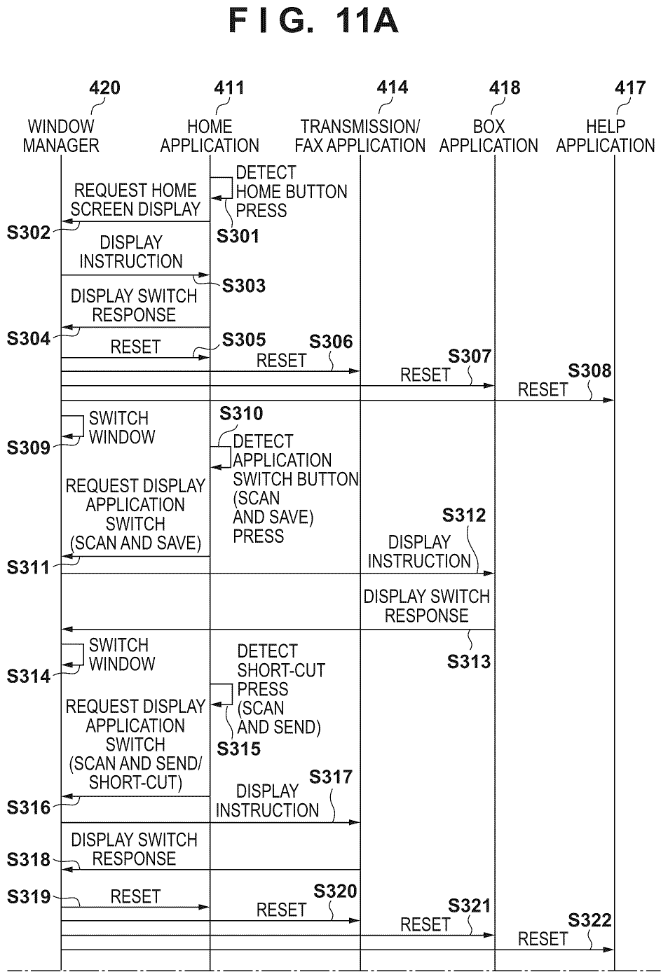

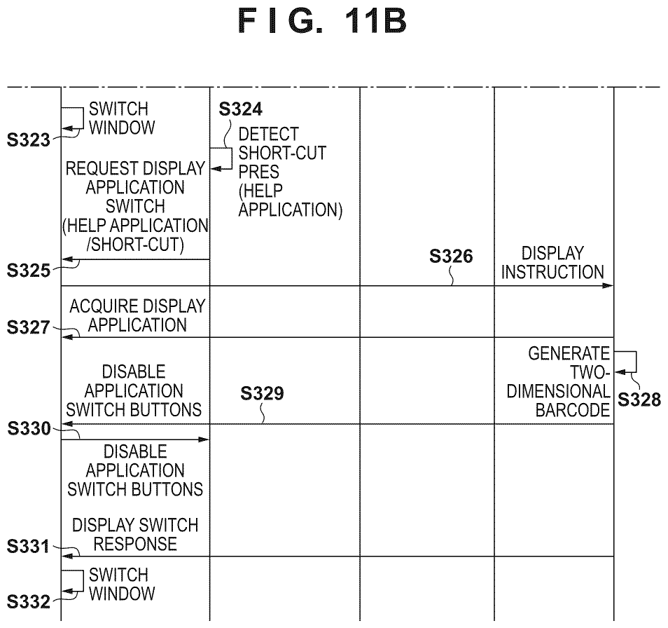

FIGS. 11A and 11B are sequence charts showing an example of processing of the operation processing unit 403 when the user presses the short-cut buttons 502 to 505 or the application switch buttons 521 to 526 in the image processing apparatus 100. The procedure shown in FIGS. 11A and 11B is held as a program in the external memory 123 or the ROM 113 and implemented by the CPU 111 loading it into the RAM 112 and executing it.

If the user presses the home button 510 in a state in which one application is displayed on the display 122, in S301, the home application 411 detects the pressing. Next, in S302, the home application 411 requests the window manager 420 to switch to the home application. Next, in S303, the window manager 420 notifies the home application 411 of a display instruction. At this time, the window manager 420 refers to the menu application information 701 and the application information 710, and determines the home application 411 as the notification destination. Next, in S304, the home application 411 performs drawing in the drawing region based on the handle notified in S102 and notifies the window manager 420 of a display switch response.

In S305 to S308, the window manager 420 notifies all the applications 411 to 419 of reset. Note that the notification is made even for applications that are not shown. Upon receiving the reset notification, each application sets itself in an initial state.

In S309, the window manager 420 switches the display to the home application 411. At this time, the window manager 420 moves, in the window stack 720, the application ID held in the menu application information 701 to the uppermost position of the window stack 720. The home screen shown in FIG. 6 is thus displayed. Also, at this time, since each application is set in the initial state, if the user switches to one of the applications from this state, the user can start an operation for the initial state.

Next, if the user presses the application switch button 524 (“scan and save”), in S310, the home application 411 detects the pressing.

In S311, the home application 411 requests the window manager 420 to switch to the application corresponding to the button whose pressing is detected in S310. At this time, the home application 411 refers to the application switch button assignment data 610, acquires an application ID “0006-0001” corresponding to the application switch button 524, and notifies the window manager 420 of it.

In S312, the window manager 420 notifies the box application 418 of a display instruction. Here, the window manager 420 searches for the application information 710 based on the application ID “0006-0001” notified from the home application in S311, and determines that the application of the notification destination is the box application 418. Also, at this time, the window manager 420 notifies the box application 418 of the application ID “0006-0001” notified from the home application. Next, in S313, the box application 418 performs drawing in the drawing region based on the handle notified in S111 and the application ID notified in S312 and notifies the window manager 420 of a display switch response.

In S314, the window manager 420 switches the display to the box application 418. At this time, the window manager 420 moves, in the window stack 720, the application ID notified in S311 to the uppermost position of the window stack 720. That is, in this example, the application ID “0006-0001” is located at the uppermost position of the window stack 720. Note that if the application ID notified in S311 does not exist in the window stack 720, the application ID is added to the uppermost position of the window stack 720. Furthermore, the window manager 420 controls such that a drawing buffer 717 corresponding to the application ID notified in S311 becomes the target of the input control unit 114 or the display control unit 115. Hence, the screen of “scan and save” (box application 418) is displayed in the application individual region 520 in FIG. 6, and the user can perform an operation using the input control unit 114. The operation target of the buttons 511 to 515 is also “scan and save”. At this time, since the box application 418 is reset in S307, the user can start an operation from the initial state of “scan and save”.

Next, if the user presses the short-cut button 503, in S315, the home application 411 detects the pressing.

In S316, the home application 411 requests the window manager 420 to switch to the application corresponding to the short-cut button whose pressing is detected in S315. At this time, the home application 411 refers to the short-cut button assignment data 600, acquires an application ID “0003-0002” corresponding to the short-cut button 503, and notifies the window manager 420 of it.

In S317, the window manager 420 notifies the transmission/FAX application 414 of a display instruction, as in S312. Next, in S318, the transmission/FAX application 414 notifies the window manager 420 of a display switch response, as in S313.

In S319 to S322, the window manager 420 notifies all the applications 411 to 419 of reset, as in S305 to S308.

In S323, the window manager 420 switches the display to the transmission/FAX application 414, as in S314. Hence, the screen of “scan and send” (transmission/FAX application 414) is displayed in the application individual region 520 in FIG. 6. At this time, since the transmission/FAX application 414 is reset in S320, the user can start an operation from the initial state of “scan and send”. Furthermore, since other applications are also set in the initial state, an operation can be started from the initial state even if the user switches to another application.

Note that an example of switching in which “scan and send” is pressed after “scan and save” is pressed has been described above. The above-described operation can be applied even in switching by another application. That is, even in switching by another application, it is possible to similarly obtain the effect of starting an operation from the initial state.

Next, if the user presses the short-cut button 505, in S324, the home application 411 detects the pressing.

In S325, the home application 411 requests the window manager 420 to switch to the application corresponding to the short-cut button whose pressing is detected in S324. At this time, the home application 411 refers to the short-cut button assignment data 600, acquires an application ID “0004-0001” corresponding to the short-cut button 505, and notifies the window manager 420 of it.

In S326, the window manager 420 notifies the help application 417 of a display instruction, as in S312. Next, in S327, the help application 417 requests the window manager 420 to acquire the application ID of the displayed application. In response to this, the window manager 420 refers to the window stack 720 and returns the application ID held at the uppermost position. At the point of this process, since the application ID “0003-0002” of “scan and send” is held at the uppermost position of the window stack 720 in S323, the application ID “0003-0002” is the return value.

In S328, the help application 417 displays display data corresponding to help contents. At this time, the help application 417 encodes a URL to a Web manual into a two-dimensional code and uses this as the help contents. To generate the URL to the Web manual, the application ID of the displayed application acquired in S327, and a model name, a destination, and display language information acquired from the device information management unit 407 are used. Next in S329, the help application 417 requests the window manager 420 to disable the application switch buttons.

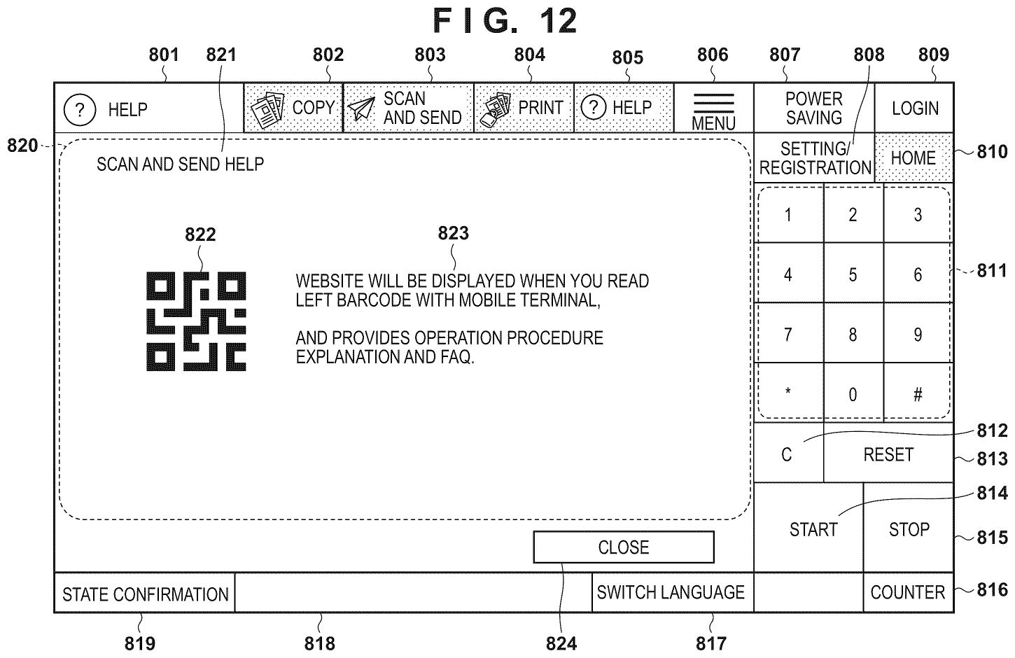

In S330, the window manager 420 requests the application (the home application 411 in this example) held in the application information 710 to disable the application switch buttons. Upon receiving the request, the home application 411 disables flags held in the button enable/disable flag 630 and corresponding to the short-cut buttons 502 to 505, the home button 510, and the application switch buttons 521 to 526. Furthermore, the home application 411 changes the display form to indicate that these buttons are disabled. For example, the color of a displayed button is changed to a predetermined color, or the character color is changed to gray. Note that in this embodiment, hatching is used, as shown in FIG. 12.

In S331, after drawing in a drawing region, the help application 417 notifies the window manager 420 of a display switch response, as in S313. Next, in S332, the window manager 420 switches the display to the help application 417, as in S314. Hence, the screen of “help” (help application 417) is displayed in the application individual region 520 in FIG. 6. On the other hand, unlike S315 to S323, each application is not reset in the sequence of S324 to S332.

FIG. 12 is a view showing an example of the screen of the help application 417 displayed in S332. A region 801 is a region to display the application name and the icon of the displayed application. In FIG. 12, since the help application 417 is displayed, the application name 465 and the icon data 466 of the help application 417 are displayed.

Short-cut buttons 802 to 805 are disabled by the process of S330. A home button 810 is also disabled by the process of S330. In a region 820, the help contents generated in S328 are displayed. A title 821 is a title generated based on the application ID acquired in S327. A barcode 822 is the two-dimensional code generated in S328. A message 823 is an explanatory note to the two-dimensional code 822. A button 824 is a button used to close the help application.

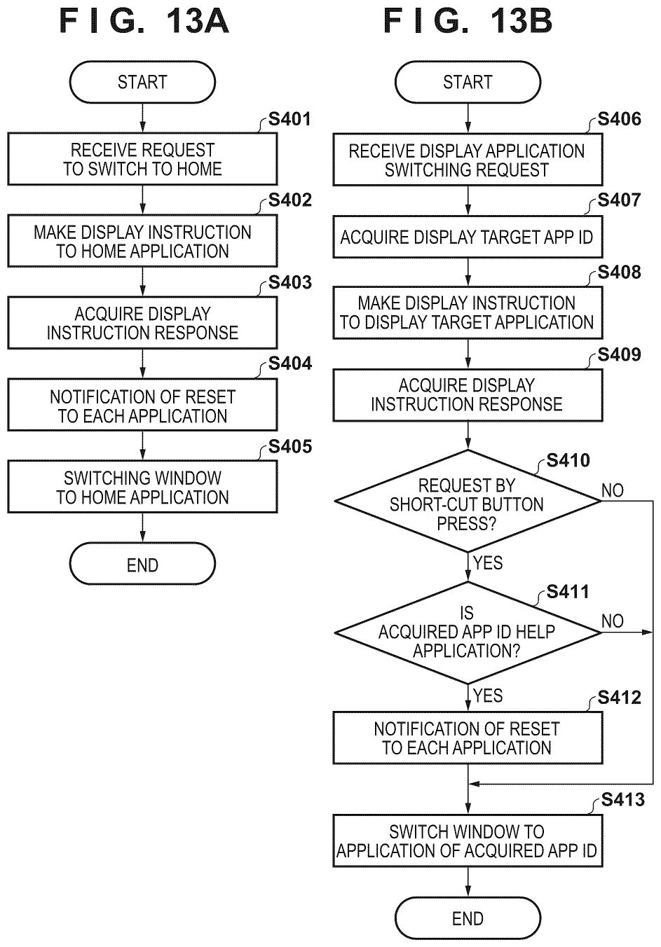

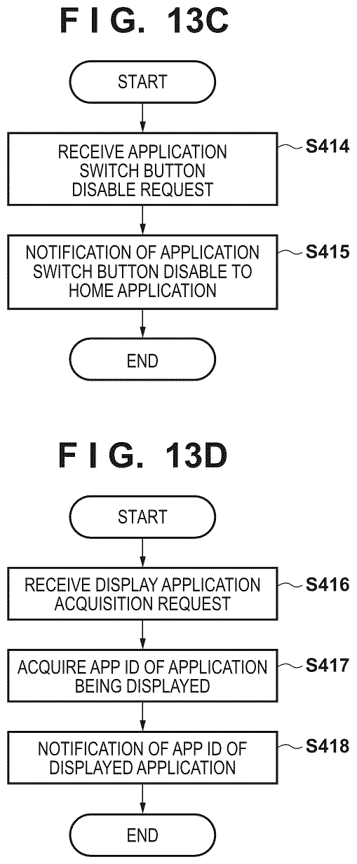

FIG. 13A is a flowchart showing processing of a request to switch to the home application 411 by the window manager 420 in the sequence shown in FIGS. 11A and 11B. The procedure shown in FIG. 13A is held as a program in the external memory 123 or the ROM 113 and implemented by the CPU 111 loading it into the RAM 112 and executing it.

First, in step S401, the window manager 420 receives the request to switch to the home application in S302 of FIGS. 11A and 11B. Next, in step S402, the window manager 420 notifies the home application 411 of a display instruction. At this time, the window manager 420 refers to the menu application information 701 and the application information 710 and determines an application having an application ID held in the menu application information 701 as a notification target.

Next, in step S403, the window manager 420 receives a response to the display instruction in step S402 from the home application 411. Next, in step S404, the window manager 420 refers to the application information 710 and notifies each application held in the application information 710 of reset.

In step S405, the display is switched to the home application 411. At this time, the window manager 420 moves, in the window stack 720, the application ID held in the menu application information 701 to the uppermost position. Note that if the application ID held in the menu application information 701 does not exist in the window stack 720, the application ID is added to the uppermost position of the window stack 720. Furthermore, the window manager 420 controls such that a drawing buffer corresponding to the application ID held in the menu application information 701 becomes the target of the input control unit 114 or the display control unit 115. After step S405, the processing of the request to switch to the home application is ended.

FIG. 13B is a flowchart showing processing of an application switching request by the window manager 420 in the sequence shown in FIGS. 11A and 11B. The procedure shown in FIG. 13B is held as a program in the external memory 123 or the ROM 113 and implemented by the CPU 111 loading it into the RAM 112 and executing it.

First, in step S406, the window manager 420 receives a display application switching request in, for example, S311 of FIGS. 11A and 11B. At this time, the display application switching request includes a display target application ID and information representing whether the display application switching request is a request by pressing a short-cut button. Next, in step S407, the window manager 420 acquires the display target application ID from the request received in step S406.

In step S408, the window manager 420 notifies a display target application of a display instruction. At this time, the window manager 420 refers to the application information 710 based on the application ID acquired in step S407, and selects an application as a notification target. In step S409, the window manager 420 receives a response from the application notified of the display instruction in step S408.

In step S410, the window manager 420 determines whether the request received in step S406 is display application switching by pressing a short-cut button. As the result of the determination, if the request received in step S406 is display application switching by pressing a short-cut button, the process advances to step S411. If the request is not display application switching by pressing a short-cut button, the process advances to step S413.

In step S411, the window manager 420 determines whether the application ID acquired in step S407 is the application ID of the application used for help. At this time, the window manager 420 refers to the help application information 730, and determines whether the application ID acquired in step S407 is the ID held in the help application information 730. For example, since the application ID “0004-0001” of the help application 417 is the same as the ID held in the help application information 730, the help application 417 is determined as the application used for help. As the result of the determination, if the application ID acquired in step S407 is the application ID of the application used for help, the process advances to step S413. if the application ID is not the application ID of the application used for help, the process advances to step S412.

In step S412, the window manager 420 refers to the application information 710 and notifies each application held in the application information 710 of reset. Next, in step S413, the window manager 420 switches the display to the application having the application ID acquired in step S407. This process is the same as the process of steps S208 and S405. After step S413, the processing of the application switching request is ended.

FIG. 13C is a flowchart showing processing of an application switch button disable request by the window manager 420 in the sequence shown in FIGS. 11A and 11B. The procedure shown in FIG. 13C is held as a program in the external memory 123 or the ROM 113 and implemented by the CPU 111 loading it into the RAM 112 and executing it.

First, in step S414, the window manager 420 receives an application switch button disable request in S329 of FIGS. 11A and 11B. Next, in step S415, the window manager 420 notifies an application (the home application 411 in this example) having an application ID held in the menu application information 701 of disabling of the application switch button. After step S415, the processing of the application switch button disable request is ended.

FIG. 13D is a flowchart showing processing of an application ID acquisition request for the displayed application by the window manager 420 in the sequence shown in FIGS. 11A and 11B. The procedure shown in FIG. 13D is held as a program in the external memory 123 or the ROM 113 and implemented by the CPU 111 loading it into the RAM 112 and executing it.

First, in step S416, the window manager 420 receives an application ID acquisition request for the displayed application in S327 of FIGS. 11A and 11B. Next, in step S417, the window manager 420 refers to the window stack 720 and acquires the application ID located at the uppermost position of the window stack 720. In step S418, the window manager 420 notifies the application that is the source of the request in step S416 of the application ID acquired in step S417. After step S418, the processing of the application ID acquisition request for the displayed application is ended.

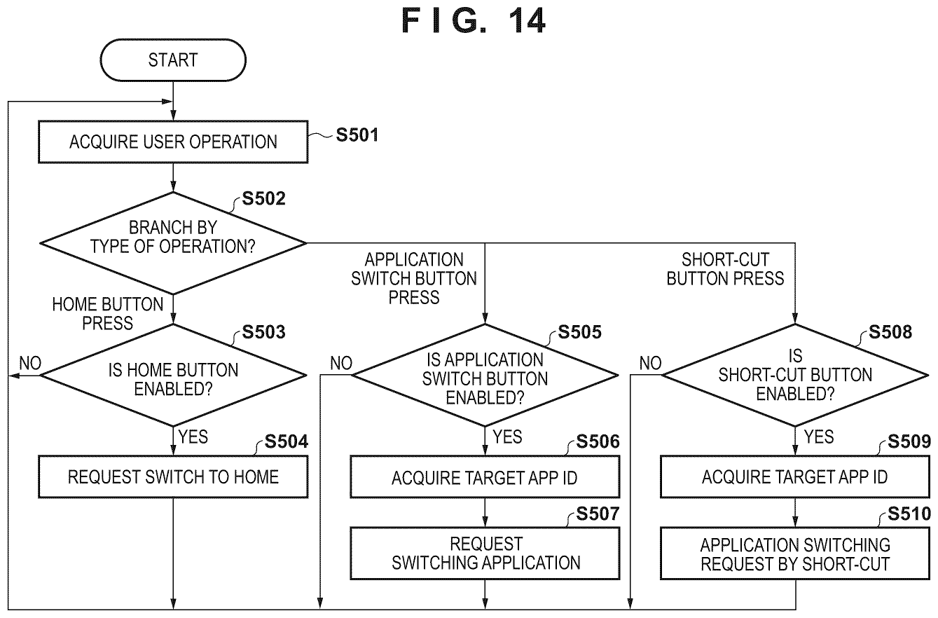

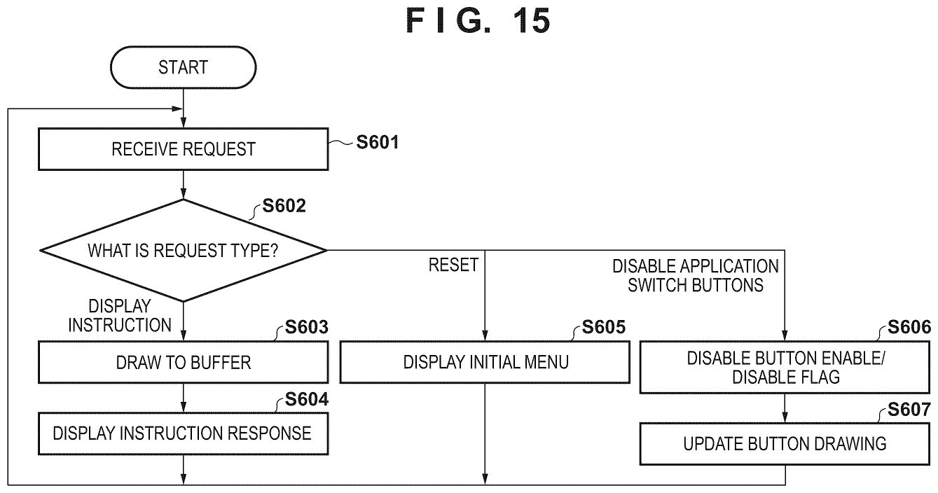

FIG. 14 is a flowchart showing processing of the home application 411 in response to a user operation in the sequence shown in FIGS. 11A and 11B. The procedure shown in FIG. 14 is held as a program in the external memory 123 or the ROM 113 and implemented by the CPU 111 loading it into the RAM 112 and executing it.

First, in step S501, the home application 411 acquires a user operation. The user operation is, for example, button pressing detected in one of S301, S310, S315, and S324. Next, in step S502, the home application 411 branches the processing in accordance with the type of the operation acquired in step S501. If the operation acquired in step S501 is pressing of the home button 510, the process advances to step S503. If the operation acquired in step S501 is an operation of one of the application switch buttons 521 to 526, the process advances to step S505. If the operation acquired in step S501 is an operation of one of the short-cut buttons 502 to 505, the process advances to step S508.

In step S503, the home application 411 refers to the button enable/disable flag 630 and determines whether the home button 510 is enabled. As the result of the determination, if the home button 510 is enabled, the process advances to step S504. If the home button 510 is not enabled, the process returns to step S501. In step S504, the home application 411 requests the window manager 420 to switch to home. After step S504, the process returns to step S501.

In step S505, the home application 411 refers to the button enable/disable flag 630 and determines whether the application switch button whose pressing is detected in step S501 is enabled. As the result of the determination, if the application switch button whose pressing is detected in step S501 is enabled, the process advances to step S506. If the application switch button is not enabled, the process returns to step S501. In step S506, the home application 411 refers to the application switch button assignment data 610, and acquires an application ID corresponding to the application switch button whose pressing is detected in step S501. Next, in step S507, the home application 411 requests the window manager 420 to switch the display application. At this time, the application ID acquired in step S506 is notified. After step S507, the process returns to step S501.

In step S508, the home application 411 refers to the button enable/disable flag 630 and determines whether the short-cut button whose pressing is detected in step S501 is enabled. As the result of the determination, if the short-cut button whose pressing is detected in step S501 is enabled, the process advances to step S509. If the short-cut button is not enabled, the process returns to step S501. In step S509, the home application 411 refers to the short-cut button assignment data 600, and acquires an application ID corresponding to the short-cut button whose pressing is detected in step S501. Next, in step S510, the home application 411 requests the window manager 420 to switch the display application by the short-cut. At this time, the application ID acquired in step S509 is notified. After step S510, the process returns to step S501.

FIG. 15 is a flowchart showing processing of the home application 411 in response to a request notified from the window manager 420 in the sequence shown in FIGS. 11A and 11B. The procedure shown in FIG. 15 is held as a program in the external memory 123 or the ROM 113 and implemented by the CPU 111 loading it into the RAM 112 and executing it.

First, in step S601, the home application 411 receives a request notified from the window manager 420. Next, in step S602, the home application 411 branches the processing in accordance with the type of the request received in step S601. If the request received in step S601 is a display instruction, the process advances to step S603. The display instruction here is, for example, the display instruction in S303. If the request received in step S601 is reset, the process advances to step S605. The reset here is, for example, reset in S305. If the request received in step S601 is disabling of an application switch button, the process advances to step S606. The disabling of an application switch button here is, for example, disabling of an application switch button in S330.

In step S603, the home application 411 performs drawing in a buffer region based on a handle returned in S102. Next, in step S604, the home application 411 notifies the window manager 420 that is the source of the received request (here, a display instruction) in step S601 of a response. After step S604, the process returns to step S601.

In step S605, the home application 411 returns the display state of the application switch buttons 521 to 526 to the initial state. For example, as shown in FIG. 6, applications displayed at the positions of the application switch buttons 521 to 526 are set to six applications at upper positions in the application switch button assignment data 610. After step S605, the process returns to step S601.

In step S606, the home application 411 sets the flags corresponding to the home button, the short-cut buttons, and the application switch buttons in the button enable/disable flag 630 to a disabled state. Next, is step S607, the home application 411 draws the display form of the home button, the short-cut buttons 502 to 505, and the application switch buttons 521 to 524 in a form indicating that these buttons cannot be pressed (display control). After step S607, the process returns to step S601.

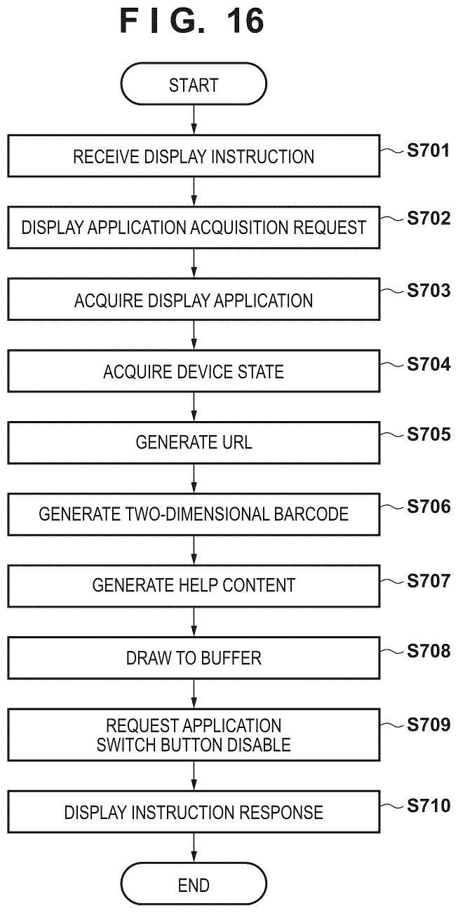

FIG. 16 is a flowchart showing processing of the help application 417 in response to a display instruction in the sequence shown in FIGS. 11A and 11B. The procedure shown in FIG. 16 is held as a program in the external memory 123 or the ROM 113 and implemented by the CPU 111 loading it into the RAM 112 and executing it.

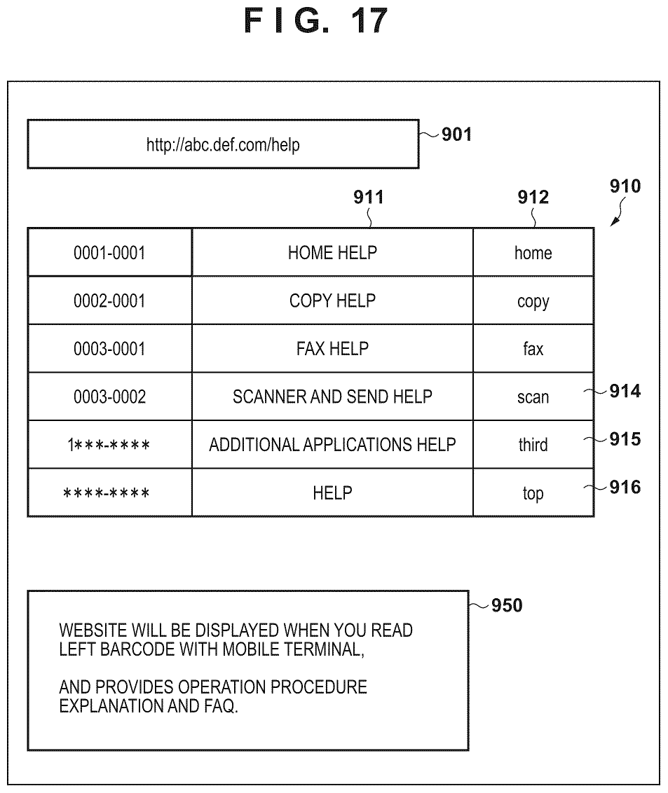

FIG. 17 shows data held by the help application 417. Referring to FIG. 17, data 901 is data indicating the URL of the Web server 209 that provides help contents. Data 910 is data that links a help screen title 911 and an application identification parameter 912 with an application ID and holds these as help contents generation information. The application identification parameter 912 is a character string used as a URL parameter to identify an application. Explanatory note data 950 is explanatory note data used to display the message 823. The help server URL 901, the data 910, and the explanatory note data 950 are held in the external memory 123 and loaded into the RAM 112 at the time of activation of the help application 417. Processing of the help application 417 in response to a display instruction will be described below with reference to the flowchart of FIG. 16.

First, in step S701, the help application 417 receives a display instruction from the window manager 420 in S326 of FIGS. 11A and 11B. Next, in step S702, the help application 417 notifies the window manager 420 of an application ID acquisition request for the displayed application. In step S703, the help application 417 acquires the application ID of the displayed application as a response to step S702. In step S704, the help application 417 acquires device information from the device information management unit 407. More specifically, for example, the model name of the image processing apparatus 100, a display language used for input/output of the operation processing unit 403, and destination information of the image processing apparatus 100 are acquired.

In step S705, the help application 417 generates a URL used to refer to a help contents server. The URL used to refer to the help contents server is generated by connecting the model name, the display language, and the destination information acquired in step S704 as parameters to the URL held in the help server URL 901. Furthermore, the help application 417 refers to the data 910 of the help contents generation information based on the application ID acquired in step S703, and acquires an application identification parameter. For example, if the application ID acquired in step S703 is “0003-0002”, “scan” is acquired as an application identification parameter 914. The application identification parameter is connected as a parameter to the URL used to refer to the help contents server. Note that if the application ID acquired in step S703 does not exist in the data 910 of the help contents generation information, a predetermined application identification parameter may be used. For example, “top” of an application identification parameter 916 is such an application identification parameter. Also, an application identification parameter may be acquired, based on a predetermined rule, from the application ID in the data 910 of the help contents generation information and the application ID acquired in step S703. For example, an application identification parameter 915 indicates that an application identification parameter “third” is used if one digit at the top of the application ID is “1”. At this time, the application ID may be added as a character string to the application identification parameter.

In step S706, the help application 417 generates a two-dimensional code image from the URL generated in step S705. In step S707, the help application 417 generates contents to be displayed in the region 820. To generate help contents, the two-dimensional code generated in step S706, the explanatory note data 950, and the help screen title 911 acquired by referring to the data 910 of the help contents generation information are used. For example, if the application ID acquired in step S703 is “0003-0002”, “help of scan and send” is used as the help screen title 911.

In step S708, the help application 417 performs drawing in a buffer region based on a handle returned in S114. More specifically, for example, the help contents generated in step S707 and the close button 824 are drawn. In step S709, the help application 417 notifies the window manager 420 of an application switch button disable request. In step S710, the help application 417 notifies the window manager 420 of a response to the display instruction received in step S701. After step S710, the processing of the help application 417 to the display instruction is ended.

By the above-described processing, the two-dimensional code is displayed as help contents on the display 122. The user can read this using the camera 303 of the portable terminal 210 and refer to help contents designated by the URL. Also, at this time, since the model name, the display language, and the destination information are added as the URL, the Web server 209 can distribute contents according to the operation state of the image processing apparatus 100 by the user. Note that in this embodiment, the explanatory note data 950 is fixed data. However, it may be held in the data 910 of help contents generation information, like the help screen title 911, and changed in accordance with the displayed application.

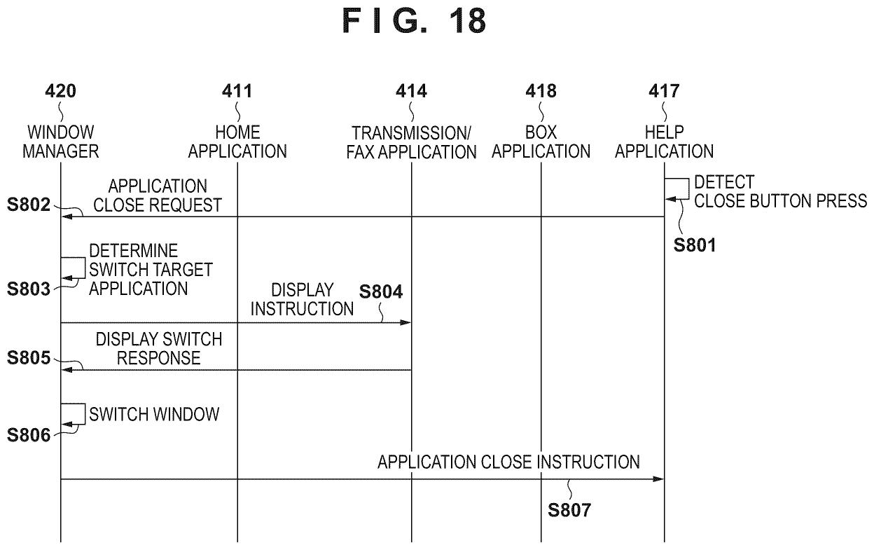

FIG. 18 is a sequence chart showing an example of processing of the operation processing unit 403 when the user presses the close button of the help application 417 in the image processing apparatus 100. The procedure shown in FIG. 18 is held as a program in the external memory 123 or the ROM 113 and implemented by the CPU 111 loading it into the RAM 112 and executing it.

If the user presses the close button 824 in a state shown in FIG. 12 in which the help application 417 is displayed on the display 122, in S801, the help application 417 detects the pressing.

Next, in S802, the help application 417 notifies the window manager 420 of an application close request. At this time, the help application 417 notifies the window manager 420 of the application ID (“0004-0001”) of its own held in the application ID 464.

In S803, the window manager 420 refers to the window stack 720 and determines the application whose display is to be switched. For example, if the window stack 720 is in the state shown in FIG. 8, the window manager 420 deletes the application ID (“0004-0001”) notified from the window stack 720 in S802. As a result, the application ID located at the uppermost position is “0003-0002”. Note that “0003-0002” will be described here as an example, but it may be another application ID. Furthermore, it is determined, based on the application information 710, that the application corresponding to “0003-0002” is the transmission/FAX application 414.

In S804, the window manager 420 notifies the application (transmission/FAX application 414) determined as the switching target in S803 of a display instruction. In S805, the transmission/FAX application 414 performs drawing in the drawing region based on the handle notified in S102 and notifies the window manager 420 of a display switch response.

In S806, the window manager 420 switches the display to the transmission/FAX application 414. In S807, the window manager 420 notifies the help application 417 of close of the application. Upon receiving the close notification, the help application 417 performs post-processing such as discard of the barcode generated in step S706.

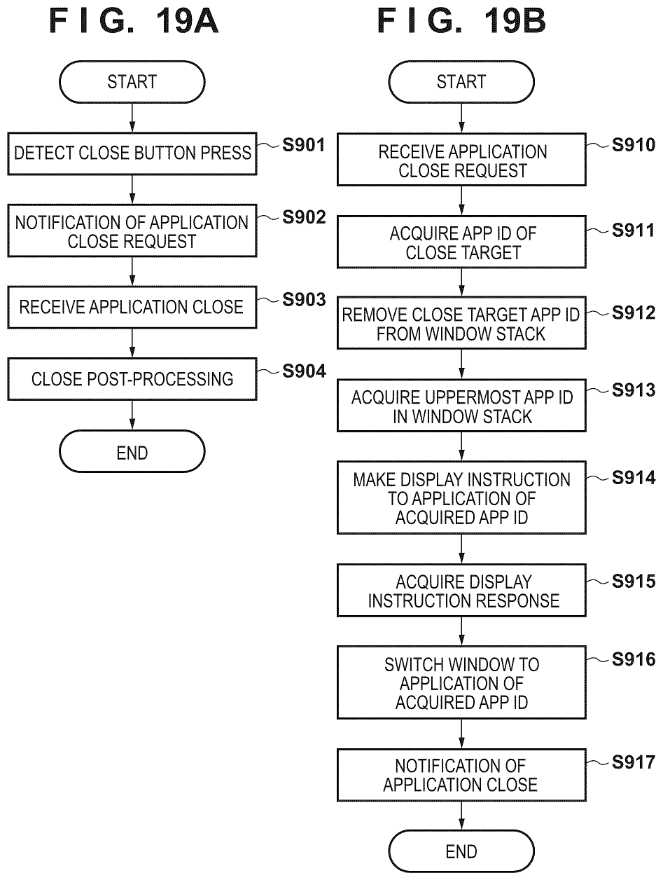

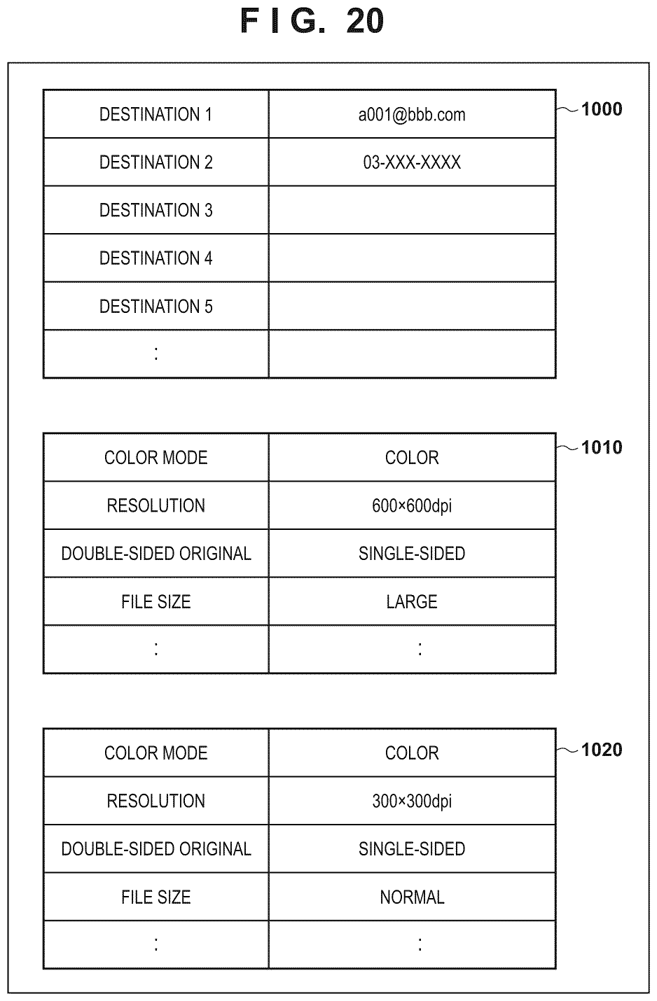

FIG. 19A is a flowchart showing processing of the help application 417 in the sequence shown in FIG. 18. The procedure shown in FIG. 19A is held as a program in the external memory 123 or the ROM 113 and implemented by the CPU 111 loading it into the RAM 112 and executing it.

First, in step S901, the help application 417 detects the pressing of the close button 824 by the user. Next, in step S902, the help application 417 notifies the window manager 420 of an application close request. At this time, the help application 417 notifies the window manager 420 of the application ID (“0004-0001”) of its own held in the application ID 464.

In step S903, the help application 417 receives, from the window manager 420, a notification of close of the application corresponding to the request in step S902. In step S904, the help application 417 performs post-processing associated with the close of the application. For example, the help application 417 discards the barcode generated in step S706. After step S904, the processing of the help application 417 in the sequence shown in FIG. 18 is ended.

FIG. 19B is a flowchart showing processing of the window manager 420 in the sequence shown in FIG. 18. The procedure shown in FIG. 19B is held as a program in the external memory 123 or the ROM 113 and implemented by the CPU 111 loading it into the RAM 112 and executing it.

First, in step S910, the window manager 420 receives an application close request. Next, in step S911, the window manager 420 acquires the application ID of the close target from the application close request received in step S910. In step S912, the window manager 420 deletes the application ID of the close target acquired in step S911 from the window stack 720. At this time, the window manager 420 moves the application ID located under the application ID of the close target to the upper position one by one in the window stack 720.

Next, in step S913, the window manager 420 acquires the application ID located at the uppermost position of the window stack 720. In step S914, the window manager 420 notifies the application corresponding to the application ID acquired in step S913 of a display instruction. In step S915, the window manager 420 receives a response to the display instruction in step S914.

In step S916, the window manager 420 switches the display to the application corresponding to the application ID acquired in step S913. In step S917, the window manager 420 notifies the application corresponding to the application ID acquired in step S911 of close of the application. After step S917, the processing of the window manager 420 in the sequence shown in FIG. 18 is ended.

FIG. 20 is a view showing an example of data held by the transmission/FAX application 414. Referring to FIG. 20, destination data 1000 is data that holds a transmission destination. The destination data 1000 holds a mail address, a FAX number, or the like as a transmission destination. As shown in FIG. 20, the destination data 1000 holds a plurality of destinations. Set value data 1010 is data that holds the set values of the transmission/FAX application 414. The set values include a color mode in original reading, a resolution, a double-sided printing setting, a file size (image compression ratio) in transmission, and the like.

Initial set value data 1020 is data that holds the initial values of the set values of the transmission/FAX application 414. The initial set value data 1020 is held in the external memory 123 and loaded into the RAM 112 at the time of activation of the transmission/FAX application 414. The set value data 1010 is held in the RAM 112, and initialized to the contents of the initial set value data 1020 at the time of activation of the transmission/FAX application 414. The destination data 1000 is held in the RAM 112. Note that the initial value of the destination data 1000 is empty.

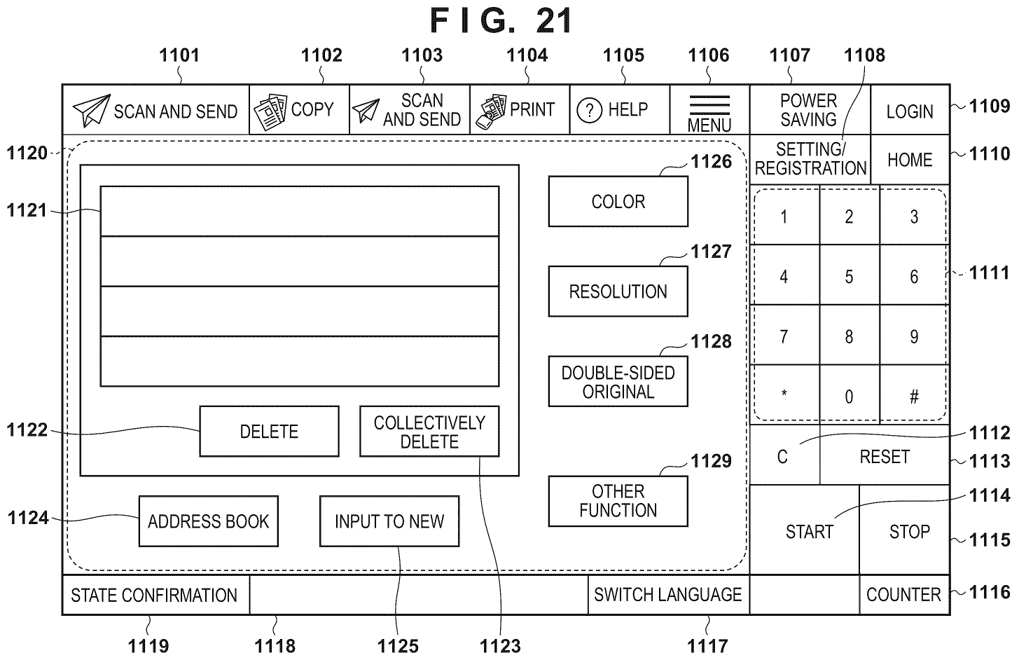

FIG. 21 is a view showing an example of the “scan and send” screen of the transmission/FAX application 414. Referring to FIG. 21, a region 1101 is a region to display the application name and the icon of the displayed application. In FIG. 21, since “scan and send” of the transmission/FAX application 414 is displayed, the application name 462 and the icon data 463 of the transmission/FAX application 414 are displayed.

A transmission destination display list 1121 is a region to display a transmission destination set by the user. As shown in FIG. 21, a plurality of transmission destinations can be set and displayed as a list in the region 1121. Also, each item of the list can individually be selected by the user.

A button 1122 is a button used to delete an item selected by the user from the transmission destination display list 1121. Note that the selected item is deleted from the destination data 1000. A button 1123 is a button used to delete all destinations set in the transmission destination display list 1121.

An address book button 1124 is a button used to display the screen of an address book. If the user presses the address book button 1124, the transmission/FAX application 414 displays an address book screen (not shown). The user can select a desired destination from the address book by operating the address book screen. The selected destination is held in the destination data 1000 and displayed in the transmission destination display list 1121.

A new destination 1125 is a button used to display a new destination input screen. If the user presses the new destination button 1125, the transmission/FAX application 414 displays the new destination input screen (not shown). The user can input an arbitrary destination by operating the new destination input screen. The input destination is held in the destination data 1000 and set in the transmission destination display list 1121.

A color mode 1126 is a button used to display a color mode setting screen. If the user presses the color mode button 1126, the transmission/FAX application 414 displays the color mode setting screen (not shown). The user can set a color mode at the time of original reading by operating the color mode setting screen. The set color mode is held in the set value data 1010.

A resolution button 1127 is a button used to display a resolution setting screen. If the user presses the resolution button 1127, the transmission/FAX application 414 displays the resolution setting screen (not shown). The user can set a resolution at the time of original reading by operating the resolution setting screen. The set resolution is held in the set value data 1010.

A double-sided original button 1128 is a button used to display a double-sided original setting screen. If the user presses the double-sided original button 1128, the transmission/FAX application 414 displays the double-sided original setting screen (not shown). The user can set an operation mode of the scanner 125 at the time of original reading by operating the double-sided original setting screen. The set double-sided original setting is held in the set value data 1010.

Another function setting button 1129 is a button used to display a setting screen for other functions. If the user presses the other function setting button 1129, the transmission/FAX application 414 displays the setting screen for other functions (not shown). The user can do settings of other functions by operating the setting screen for other functions. The set values are held in the set value data 1010. Remaining buttons and regions 1102 to 1119 are the same as the regions 502 to 519 in FIG. 6, and a description thereof will be omitted.

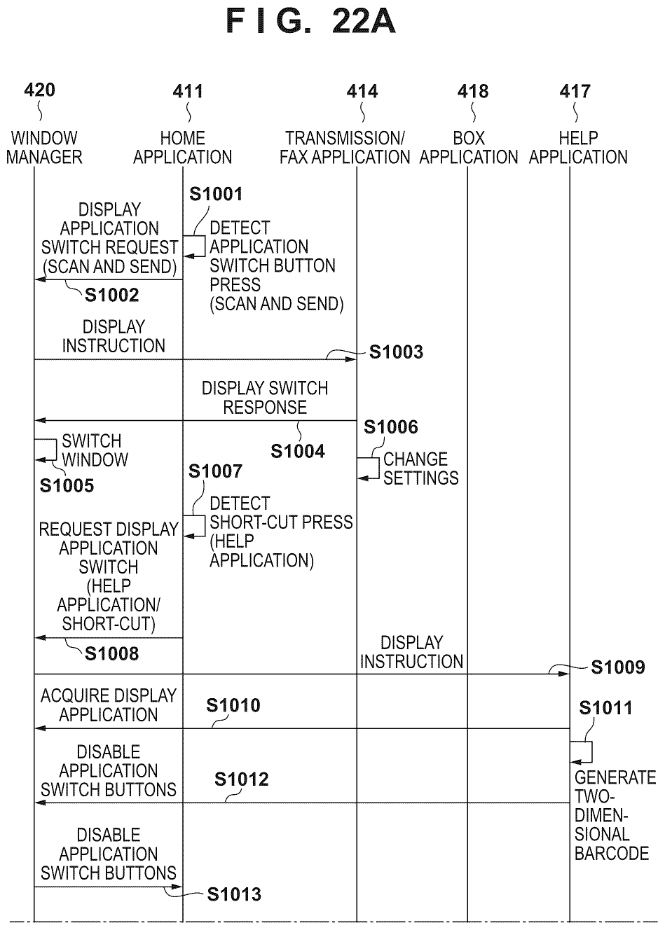

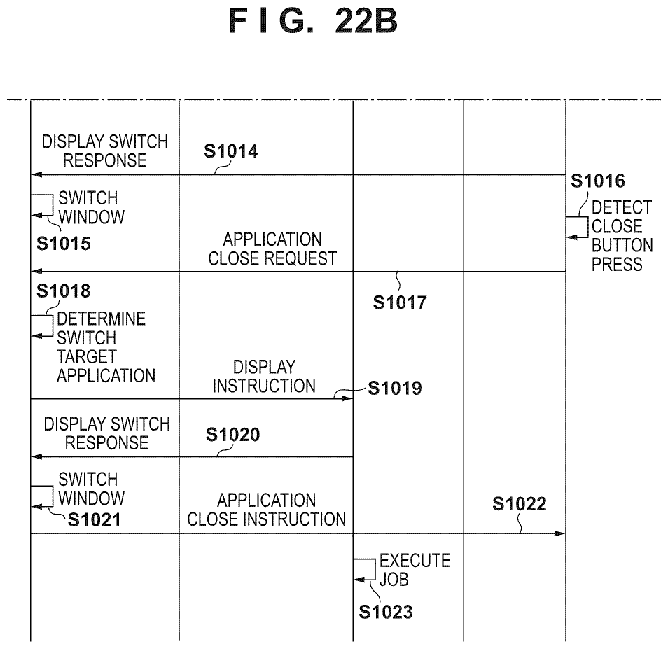

FIGS. 22A and 22B are sequence charts showing an example of processing of the operation processing unit 403 when the buttons displayed on the screens of the home application 411, the transmission/FAX application 414, and the help application 417 are operated in the image processing apparatus 100. The procedure shown in FIGS. 22A and 22B is held as a program in the external memory 123 or the ROM 113 and implemented by the CPU 111 loading it into the RAM 112 and executing it.

If the user presses the application switch button 523 “scan and send” in a state shown in FIG. 6 in which the home application 411 is displayed on the display 122, in S1001, the home application 411 detects the pressing. Next, in S1002, the home application 411 requests the window manager 420 to switch to the application (“scan and send” of the transmission/FAX application 414) corresponding to the button whose pressing is detected in S1001. The processes of S1003 to S1005 are the same as the processes of S312 to S314, and a description thereof will be omitted. As the result of S1001 to S1005, the screen shown in FIG. 21 is displayed on the display 122.

In S1006, the transmission/FAX application 414 accepts a user operation for each button arranged in FIG. 21 and changes the transmission destination and transmission settings. The changed transmission destination and transmission settings are held in the destination data 1000 and the set value data 1010. Here, if the user presses the short-cut button 1105, in S1007, the home application 411 detects the pressing. The processes of S1008 to S1015 are the same as the processes of S325 to S332, and a description thereof will be omitted. As the result of S1008 to S1015, the screen shown in FIG. 12 is displayed on the display 122.

Here, if the user presses the close button 824, in S1016, the help application 417 detects the pressing. The processes of S1017 to S1022 are the same as the processes of S802 to S807, and a description thereof will be omitted. As the result of S1017 to S1022, a screen before the short-cut button 1105 is pressed in S1007 is displayed on the display 122. That is, the screen of the application before the short-cut button 1105 is pressed, which is the screen in which the set values before the short-cut button 1105 is pressed are maintained is displayed.

Here, if the user presses the start button 1114, the transmission/FAX application 414 detects the pressing and executes a transmission job. At this time, the transmission destination and the transmission settings set in S1006 are not reset, and are held in the destination data 1000 and the set value data 1010. For this reason, the transmission job is executed using the transmission destination and the transmission settings set in S1006.

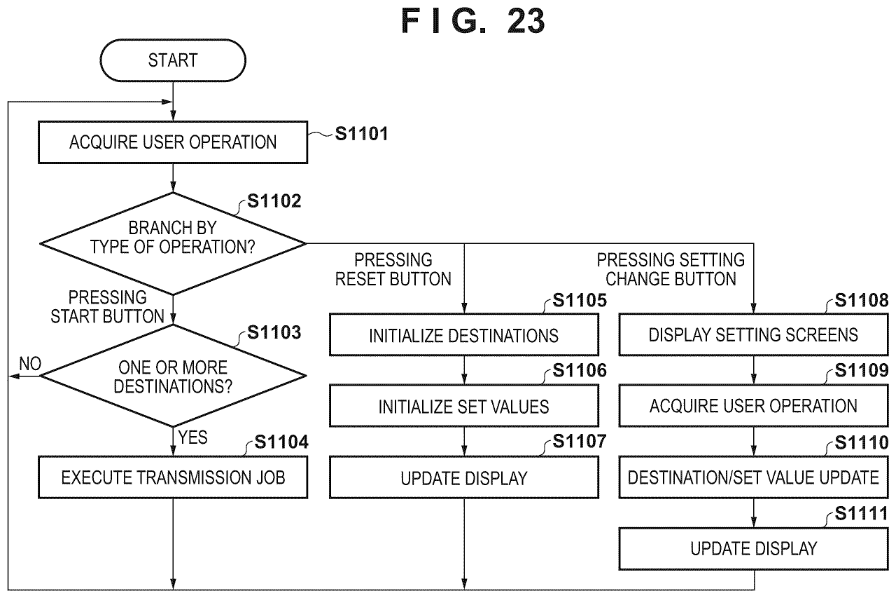

FIG. 23 is a flowchart showing processing of the transmission/FAX application 414 in response to a user operation. The procedure shown in FIG. 23 is held as a program in the external memory 123 or the ROM 113 and implemented by the CPU 111 loading it into the RAM 112 and executing it.

First, in step S1101, the transmission/FAX application 414 acquires a user operation. Next, in step S1102, the transmission/FAX application 414 branches the processing in accordance with the type of the operation acquired in step S1101. If the operation acquired in step S1101 is the operation of the start button 1114, the process advances to step S1103. If the operation acquired in step S1101 is the operation of the reset button 1113, the process advances to step S1105. If the operation acquired in step S1101 is the operation of each button arranged in an application individual region 1120, the process advances to step S1108.

In step S1103, the transmission/FAX application 414 refers to the destination data 1000, and determines whether one or more destinations are held in the destination data 1000. As the result of the determination, if one or more destinations are held in the destination data 1000, the process advances to step S1104. If no destination is held, the process returns to step S1101. In step S1104, the transmission/FAX application 414 drives the job processing unit 402 based on the destination held in the destination data 1000 and settings held in the set value data 1010, and executes a transmission job. After step S1104, the process returns to step S1101.

In step S1105, the transmission/FAX application 414 erases all destinations held in the destination data 1000. Next, in step S1106, the transmission/FAX application 414 overwrites the set values held in the set value data 1010 with the set values held in the initial set value data 1020. In step S1107, the transmission/FAX application 414 updates the contents displayed in the application individual region 1120 based on the destination data 1000 and the set value data 1010. After step S1107, the process returns to step S1101.

In step S1108, the transmission/FAX application 414 displays various kinds of setting screens in the application individual region 1120 in accordance with the operation contents acquired in step S1101. In step S1109, the transmission/FAX application 414 acquires an operation from the user to the screen displayed in step S1108. In step S1110, the transmission/FAX application 414 updates the destination held in the destination data 1000 and the set values held in the set value data 1010 based on the operation acquired in step S1109. In step S1111, the transmission/FAX application 414 closes the screen displayed in step S1108. Furthermore, the contents displayed in the application individual region 1120 are updated based on the destination data 1000 and the set value data 1010. After step S1111, the process returns to step S1101.

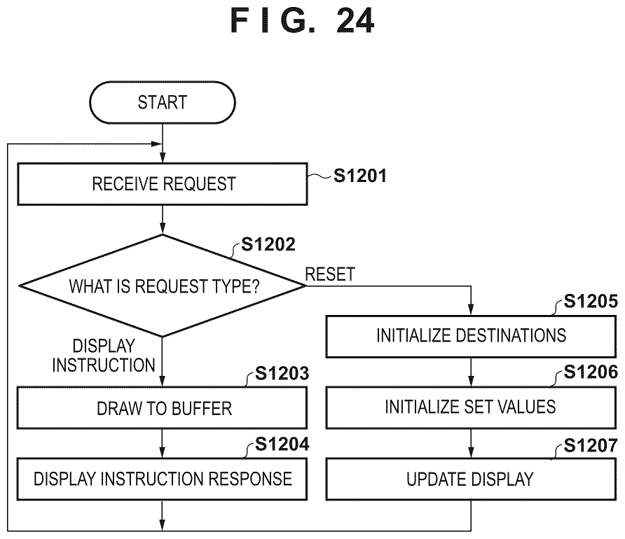

FIG. 24 is a flowchart showing processing of the transmission/FAX application 414 in response to a request notified from the window manager 420. The procedure shown in FIG. 24 is held as a program in the external memory 123 or the ROM 113 and implemented by the CPU 111 loading it into the RAM 112 and executing it.

First, in step S1201, the transmission/FAX application 414 receives a request notified from the window manager 420. Next, in step S1202, the transmission/FAX application 414 branches the processing in accordance with the type of the request received in step S1201. If the request received in step S1201 is a display instruction, the process advances to step S1203. If the request received in step S1201 is reset, the process advances to step S1205.

In step S1203, the transmission/FAX application 414 performs drawing in a buffer region based on a handle returned in S107. Next, in step S1204, the transmission/FAX application 414 notifies the window manager 420 that is the source of the request (here, a display instruction) received in step S1201 of a response. After step S1204, the process returns to step S1201.

In step S1205, the transmission/FAX application 414 erases all destinations held in the destination data 1000. Next, in step S1206, the transmission/FAX application 414 overwrites the set values held in the set value data 1010 with the set values held in the initial set value data 1020. In step S1207, the transmission/FAX application 414 updates the contents displayed in the application individual region 1120 based on the destination data 1000 and the set value data 1010. After step S1207, the process returns to step S1201.

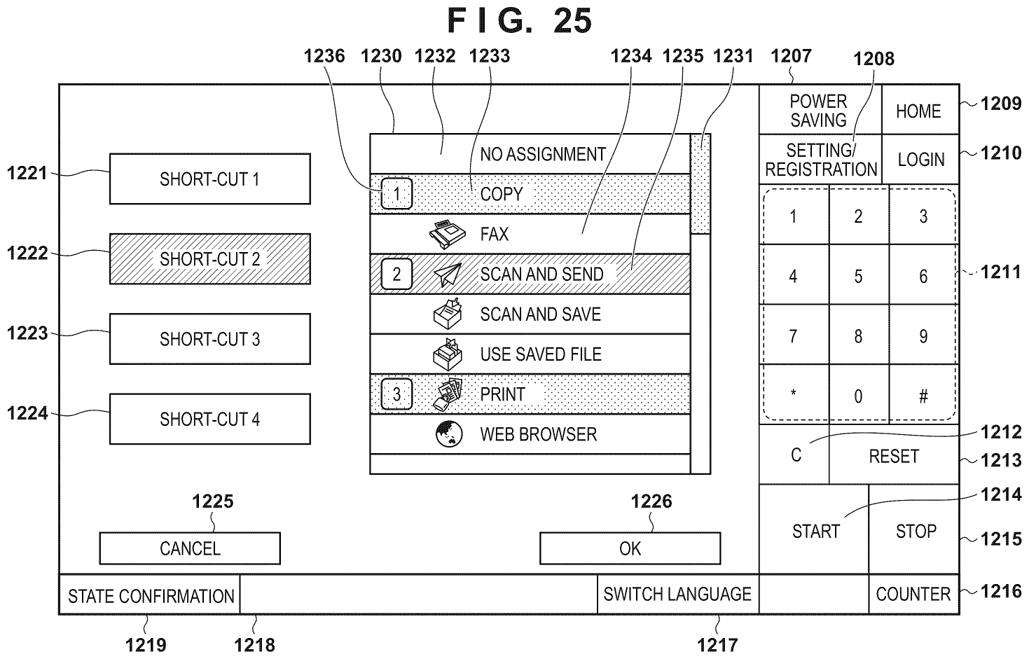

FIG. 25 is a view showing an example of a screen configured to change application assignment to the short-cut buttons 502 to 505 in the home application 411. The screen shown in FIG. 25 is invoked from a screen (not shown) displayed by pressing the menu button 506.

In the screen shown in FIG. 25, buttons 1221 to 1224 are buttons used to select a change target short-cut. The selection of the buttons 1221 to 1224 is done exclusively. If the user presses one button, the pressed button is selected, and selection of another button is canceled. In FIG. 25, the button 1222 is selected.

An application selection list 1230 is a list used to select an application corresponding to a short-cut. In the application selection list 1230, of applications installed in the image processing apparatus 100, all applications assignable to the short-cut buttons are displayed. An item that is not displayed in the application selection list 1230 can be displayed by operating as scroll bar 1231.

An item 1232 of the application selection list 1230 is an item indicating that no application is assigned to the target short-cut. Display control is performed such that an item already assigned to a short-cut that is not selected by the short-cut selection buttons 1221 to 1224 is displayed with hatching and cannot be selected. For example, a second item 1233 shown as “copy” in FIG. 25 cannot be selected because it is already assigned to the short-cut button 1102. An application set in the selected short-cut button 1222 is displayed in a reversed state in the application selection list 1230. If the user selects another item, the reverse display position shifts to the selected item. For example, if the user presses (selects) a “FAX” item 1234 in FIG. 25, the item 1234 is displayed in a reverse state, and selection of an item 1235 is canceled. Also, a number 1236 displayed at the left end of an item in the application selection list 1230 indicates the number of the short-cut button as a registration target. A button 1225 is a button used to close the screen without reflecting the displayed state on the settings. A button 1226 is a button used to close the screen after reflecting the displayed state on the settings. Remaining buttons and regions 1207 to 1219 are the same as the regions 507 to 519 in FIG. 6.

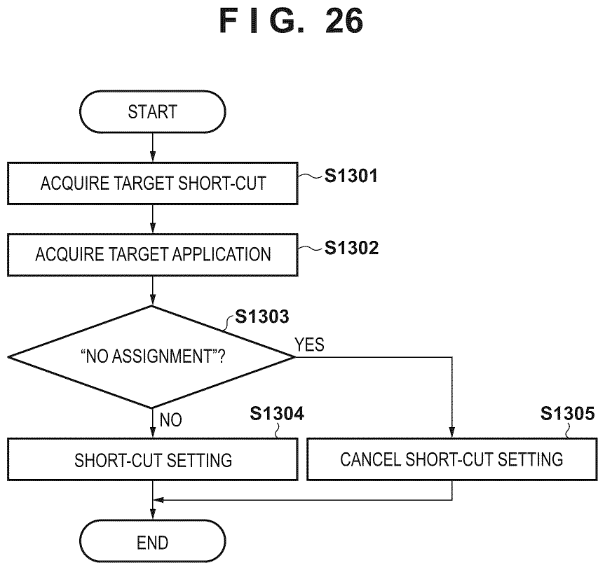

FIG. 26 is a flowchart showing processing executed by the home application 411 when changing application assignment to the short-cut buttons 502 to 505. The procedure shown in FIG. 26 is held as a program in the external memory 123 or the ROM 113 and implemented by the CPU 111 loading it into the RAM 112 and executing it.

First, in step S1301, the home application 411 acquires a short-cut as the processing target. For example, for the short-cut selection button 1221, the short-cut button 502 and a first item 601 of the short-cut button assignment data 600 are the processing target. Next, in step S1302, the home application 411 acquires an application assigned to the processing target acquired in step S1301 in the application selection list 1230.

In step S1303, the home application 411 determines whether the application acquired in step S1302 has “no assignment”. As the result of the determination, if the application acquired in step S1302 has “no assignment”, the process advances to step S1305. If the application acquired in step S1302 does not have “no assignment”, the process advances to step S1304.

In step S1304, the home application 411 assigns the application acquired in step S1302 to the processing target acquired in step S1301. After step S1304, the processing of changing application assignment to the short-cut button is ended.

In step S1305, the home application 411 cancels the assignment of the short-cut button to the processing target acquired in step S1301. That is, the home application 411 empties the corresponding item in the short-cut button assignment data 600. After step S1305, the processing of changing application assignment to the short-cut button is ended.

As described above, according to this embodiment, as described with reference to FIGS. 11A and 11B, when using an application, various kinds of settings are reset to the initial state. On the other hand, as described with reference to FIGS. 22A and 22B, in a case where the help application 417 is displayed during display of an application, and the display then returns to the original application, the original application is not reset, and the set values are maintained. Hence, the user can invoke the help application 417 even halfway through setting of the application and need not redo the setting.

Furthermore, since the home button 510 and the short-cut buttons 502 to 505 are disabled (incapable of accepting a user operation) during display of the help application 417, the user never erroneously presses the buttons to reset the application.

Also, according to this embodiment, as described with reference to FIG. 26, the application assigned to the short-cut button 505 can be changed from the help application 417 to another application. Hence, a user (for example, a skilled user) who does not use the help application 417 can efficiently use the applications by, for example, assigning another application to the short-cut button.

Furthermore, in this embodiment, as described with reference to FIGS. 11A and 11B, the help application 417 acquires the application ID of the displayed application from the window manager 420 and uses it to generate contents. That is, the help application 417 does not directly cooperate with another application. Hence, each application does not depend on the configuration of the help application 417. That is, independency between the applications is high. Also, if the application ID is added as a URL parameter, it is possible to provide appropriate help contents even to an application installed later only by processing on the side of the Web server 209.

If the help application is an initial application, no contents are acquired in step S703 (no application is being displayed). In this case, a special application identification parameter may be used in step S705 to generate help contents for initial display. In this case, the close button 824 is not displayed in step S708. Alternatively, a configuration that inhibits selection of the help application as an initial application may be adopted.

In this embodiment, if a state confirmation screen is opened by pressing the state confirmation button in the state shown in FIG. 12, in which the screen of the help application 417 is displayed, the screen of the help application 417 may be closed.

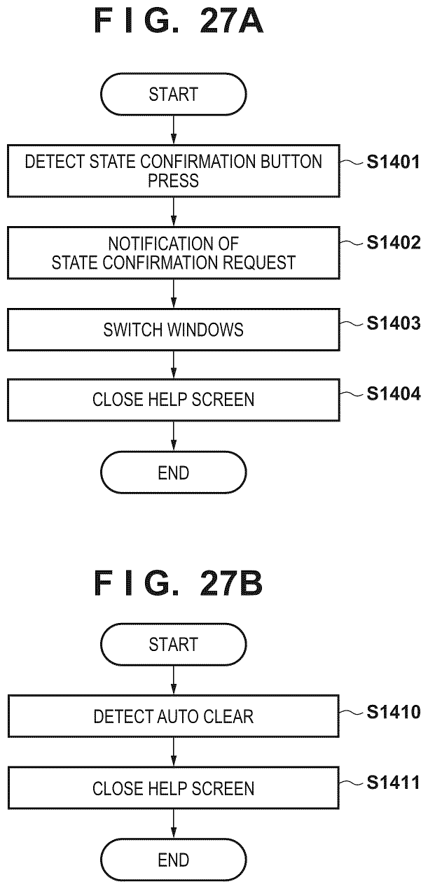

FIG. 27A is a flowchart showing processing in a case where the state confirmation screen is opened during display of the screen of the help application 417. The procedure shown in FIG. 27A is held as a program in the external memory 123 or the ROM 113 and implemented by the CPU 111 loading it into the RAM 112 and executing it.

First, in step S1401, the home application 411 detects pressing of a state confirmation button 819. When the user presses the state confirmation button 819, the home application 411 detects the pressing and requests the window manager 420 to switch to the application corresponding to the button whose pressing is detected. Next, in step S1402, the window manager 420 notifies the state confirmation/stop application 412 of a display instruction. Here, the window manager 420 refers to the application information 710 based on the application ID transmitted from the home application 411 in step S1401, and determines that the application of the notification destination is the state confirmation/stop application 412. The state confirmation/stop application 412 performs drawing in a predetermined buffer region based on a handle notified in the processing shown in FIG. 9.

In step S1403, the window manager 420 switches the display to the state confirmation/stop application 412. At this time, the window manager 420 notifies the help application 417 that the window stack 720 is updated, and the help application 417 is not the application at the uppermost position anymore. In step S1404, the help application 417 detects that the help application 417 is not the application at the uppermost position, and closes the help screen. This process is the same as the process of step S902 to S904.

Thus, the help application 417 is not displayed when the user closes the state confirmation screen. For this reason, the layer structure of the window is simple, and the user can easily ascertain the state.

In this embodiment, if auto clear is executed, the screen of the help application 417 may be closed.

FIG. 27B is a flowchart showing processing in a case where auto clear is executed during display of the screen of the help application 417. The procedure shown in FIG. 27B is held as a program in the external memory 123 or the ROM 113 and implemented by the CPU 111 loading it into the RAM 112 and executing it.

First, in step S1410, the help application 417 detects an auto clear event. The auto clear event is issued by the timer processing unit 405 when no operation from the user exists for a predetermined period, and notified to the help application 417 via the window manager 420. Next, in step S1411, the help application 417 closes the help screen. This is the same processing as steps S902 to S904.

Also, in this embodiment, the help application 417 encodes the ULR to the Web manual into a two-dimensional code and uses this as the help contents. However, contents may be acquired from the Web server 209 based on the URL to the Web manual and drawn by the help application 417. At this time, the help application 417 requests the Web browser application 415 to analyze/draw the contents, and only display may be performed by the help application 417.

In this embodiment, the operation processing unit 403 is implemented in the image processing apparatus 100 but may be implemented in the portable information terminal 210. In this case, the operation processing unit 403 communicates with the job processing unit 402 and the like via the network 203, thereby implementing the operation according to this embodiment.

If the image processing apparatus 100 is set in the power saving state by pressing of the power saving button 507 by the user or processing of the timer processing unit 405, the screen of the help application 417 may be closed. As the processing in this case, the event detected in step S1410 in the flowchart of FIG. 27B is changed to an event that occurs due to a change of the power saving state. If the user logs in to or logs out from the image processing apparatus 100 by pressing the authentication button 509, the screen of the help application 417 may be closed. As the processing in this case, the event detected in step S1410 in the flowchart of FIG. 27B is changed to a login or logout event notified from the authentication processing unit 404.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-112471, filed Jul. 7, 2023, which is hereby incorporated by reference herein in its entirety.

What is claimed is:

1. An information processing apparatus comprising:
one or more memories that store instructions; and
one or more processors configured to execute the instructions stored in the one or more memories to
accept an instruction for displaying a screen corresponding to each of a plurality of applications; and
perform, based on the accepted instruction, display control to display a screen of an application corresponding to the instruction,
wherein in the display control, in a case where, in a state in which a screen of a first application among the plurality of applications is displayed, the instruction for displaying a screen of a second application different from the first application is accepted, control is performed such that display is switched from the screen of the first application to a screen of the second application, and
in a case of switching the display from the screen of the second application to the screen of the first application,
(a) if the second application is not a predetermined application, the screen of the first application that is initialized is displayed, and
(b) if the second application is the predetermined application, the screen of the first application that is not initialized is displayed.

2. The apparatus according to claim 1, wherein if the instruction for displaying the screen of the first application is accepted in a state in which the screen of the second application that is not the predetermined application is displayed, the screen of the first application is displayed in a state in which a set value of the first application is initialized.

3. The apparatus according to claim 1, wherein if the instruction for the screen of the first application is accepted in a state in which a screen of the predetermined application is displayed, the screen of the first application is displayed in a state in which a set value of the first application is not initialized.

4. The apparatus according to claim 3, wherein the set value of the first application maintains a set value before the screen of the second application is displayed.

5. The apparatus according to claim 1, wherein in a state in which a screen of the predetermined application is displayed, an instruction for displaying a screen corresponding to an application different from the predetermined application among the plurality of applications cannot be accepted.

6. The apparatus according to claim 1, wherein
in the display control, a display instruction is performed for an application corresponding to the instruction, and
the application that receives the display instruction draws a screen of the application in a drawing region.

7. The apparatus according to claim 1, wherein each of the plurality of applications corresponds to a function executable by the information processing apparatus.

8. The apparatus according to claim 7, wherein the predetermined application corresponds to a help function.

9. The apparatus according to claim 8, wherein the predetermined application generates display data corresponding to contents of the help function and performs drawing in a drawing region based on the display data.

10. The apparatus according to claim 9, wherein the display data includes a two-dimensional code.

11. The apparatus according to claim 9, wherein
in the display control, for the predetermined application, information of the first application displayed before a screen of the predetermined application is displayed is transferred to the predetermined application, and
the predetermined application generates the display data corresponding to the first application based on the information of the first application.

12. The apparatus according to claim 8, wherein in a case of accepting the instruction, the instruction can be accepted by a button displayed on a home screen.

13. The apparatus according to claim 12, wherein the button includes a short-cut button.

14. The apparatus according to claim 8, wherein if control is performed to display a screen of a second predetermined application different from the predetermined application based on the instruction in a state in which a screen of the predetermined application is displayed, in the display control, the screen of the predetermined application is closed, and the screen of the second predetermined application is displayed.

15. The apparatus according to claim 14, wherein the second predetermined application corresponds to a function of confirming a state of the information processing apparatus.

16. The apparatus according to claim 1, wherein the information processing apparatus is an image processing apparatus capable of executing at least one of a print function and a scan function.

17. A method for an information processing apparatus, the method comprising:
accepting an instruction for displaying a screen corresponding to each of a plurality of applications; and
performing, based on the accepted instruction, display control to display a screen of an application corresponding to the instruction,
wherein in the display control, in a case where, in a state in which a screen of a first application among the plurality of applications is displayed, the instruction for displaying a screen of a second application different from the first application is accepted, control is performed such that display is switched from the screen of the first application to a screen of the second application, and
in a case of switching the display from the screen of the second application to the screen of the first application,
(a) if the second application is not a predetermined application, the screen of the first application that is initialized is displayed, and
(b) if the second application is the predetermined application, the screen of the first application that is not initialized is displayed.

18. A non-transitory computer-readable storage medium that stores one or more programs including instructions, which when executed by one or more processors of the information processing apparatus, cause the information processing apparatus to perform a control method, the control method comprising:
accepting an instruction for displaying a screen corresponding to each of a plurality of applications; and
performing, based on the accepted instruction, display control to display a screen of an application corresponding to the instruction,
wherein in the display control, in a case where, in a state in which a screen of a first application among the plurality of applications is displayed, the instruction for displaying a screen of a second application different from the first application is accepted, control is performed such that display is switched from the screen of the first application to a screen of the second application, and
in a case of switching the display from the screen of the second application to the screen of the first application,
(a) if the second application is not a predetermined application, the screen of the first application that is initialized is displayed, and
(b) if the second application is the predetermined application, the screen of the first application that is not initialized is displayed.
